(19) United States
(12) Patent Application Publication
(10) Pub. No.: US 2015/0073777 A1
(43) Pub. Date: Mar. 12, 2015

(54) SYSTEM AND METHOD FOR DETERMINING SEMANTICS AND THE PROBABLE MEANING OF WORDS

(71) Applicant: Brian Assam, Sioux Falls, ND (US)

(72) Inventor: Brian Assam, Sioux Falls, ND (US)

(21) Appl. No.: 14/469,507

(22) Filed: Aug. 26, 2014

Related U.S. Application Data
(60) Provisional application No. 61/874,958, filed on Sep. 6, 2013.

(51) Int. Cl. G06F 17/27

(52) U.S. Cl. CPC G06F 17/2785
USPC 704/9

(57) ABSTRACT

Provided are a system and method to determine semantics and the probable meaning and/or context of words. The method includes for at least one First Entity, gathering Metadata from at least one posting by a First User on a First Social Network to define at least one First Field associated with the First Entity, provided by the at least one First User and occurring in the at least one posting. Each First Field associated with the First Entity has an initial system generated value. The method continues by evaluating Responses to the posting by at least one Third Party, and in response to the Third Party using one or more of the First Fields associated with the First Entity in the Response, incrementing the value of each used First Field associated with the First Entity by the addition of a system generated value. The method provides an indication of relevance for each First Field in relation to at least one Second Field associated with each First Entity, the indication of relevance permitting a determination of semantics for each associated Field of the First Entity. An associated system is also provided.

### CROSS REFERENCE TO RELATED APPLICATIONS

This application claims the benefit under 35 U.S.C. §119(e) of U.S. Provisional Application No. 61/874,958 filed on Sep. 6, 2013 and entitled System And Method For Determining Semantics And The Probable Meaning Of Words, the disclosure of which is incorporated herein by reference.

### FIELD OF THE INVENTION

The present invention relates to a system and a method for determining semantics and the probable meaning and/or context of words as they relate to different Internet Entities; such as other words, people, posts, Discussions, groups, communities, pictures, videos, advertisements, products, and more. More specifically, through determining a value for Fields (i.e. tags, keywords, keyterms, phrases, text, etc.) as they are used in online Community Discussions, a chain of relevance is established between the Fields and the varying Entities they relate to. Through establishing a measurement of relevance between varying Fields as they relate to various Entities, the probable meaning of words can be determined for the objects that comprise the social Web, in order to provide more relevant, accurate and meaningful connections between people and information resources.

### BACKGROUND

The Internet is rapidly becoming a global community of social engagement, information exchange, and knowledge transfer. This growth in connectivity, coinciding with the evolution of hand held devices and other Web access points, makes Internet usage and socialization a growing part of our immediate, everyday lives. Evolving Social Networks, search engines, and online communities that represent every aspect of our society are creating an increasing social complexity and a glut of social data and information that is challenging the effectiveness and authenticity of the Internet's open-source architecture. The Web, as an open-decentralized environment, requires a universal solution for validating and understanding online users, along with information resources, social media, groups, online communities, etc., that are accurate and authentic and doesn't compromise information privacy.

One increasing concern and challenge to Web socialization comes in the form of semantics, or, accurate understanding of the meaning of words as they relate between people and information resources. When the Internet is used as a device to communicate, or for sharing information, albeit through study, research, education, recreation, travel, business, and so forth, there is a challenge in understanding how specific words relate to different people's interests, different contexts, or different subjects of content or information. When searching for the word “Jaguar,” most search engines or tools for matching information are challenged by the multiple meaning of the word “Jaguar;” does it refer to a “jungle cat,” an “NFL sports team,” or a “fancy car?”

Likewise random communities, information services, advertisements, and so forth may be trying to match similar words that mean different things. For instance, referencing someone named “MJ” could result in additional information about “Michael Jackson,” or “Michael Jordan.”

As users become more reliant upon search engines, queries, or tools for navigation to find information, it is very desirable for these technologies to be more accurate in identifying and providing meaningful results. When it comes to the Web, people want faster and more efficient ways to discover the right information from the right people at the right time. The ability to understand the meaning of words as they relate to various social objects—users, posts, discussions, groups, communities, social media, etc.—significantly improves the social benefits of the Internet for education, business, research, development, technology, science, government, advertising, social security, crises management, etc.

Generally there is a growing need for social networks, online communities, and other Web resources to provide more meaningful connections between people and information. The challenge of establishing semantics over a non-subjective medium lies in understanding such an expression as “Hot Dog.” Does this mean the food, a canine with an elevated blood pressure or an expression of amazement? Likewise the word “Jaguar” could be a “jungle cat,” a “luxury vehicle” or “the NFL sports team” from “Jacksonville.” Misunderstanding the context of association between the terms may and often does, result in erroneous results in data used for search, analysis, research, targeting, managing, education, etc.

Also, a user group or community might have different interests that linguistically look or sound the same, such as “Surfing Mexico” and also “Surfing the Web” which mean two totally different things. What is necessary is a way to differentiate between the use of the same term “Surfing” as it relates to other terms “Mexico” or “The Web” in order to more accurately match people and information to elements that match what these varying terms actually mean.

In essence, a word may mean something entirely different or only slightly different from one person to the next. This is a rudimentary problem with an open-social architecture such as the Internet, especially when there is no standard for understanding the relevant meaning of words as they apply to people and information resources across a variety of different platforms. This means that semantics, and the probable meaning of words, depends upon a non-local source that considers the relationships between words as they apply to various Internet entities, such as people, discussions, groups, communities, and other information resources, against the local context in which words are being used.

Subsequently the ability to recognize the probable meaning of words not only benefits the end User, but also communities, businesses, institutions, governments, and all forms of organizations by enhancing searching, querying, parsing, ranking, organizing, understanding, analyzing, managing content, etc., including every form of information related to: big data, consumer trends, demographics, ad targeting, market research, product analysis, social studies, etc.

In some cases, search engines permit a search wherein a first term is used within X words or characters of a second term. Though perhaps helpful for identifying specific documents or articles, this methodology does not scale to groups, discussions, articles, communities or other related entities and still may not recognize the context as intended by the author. Moreover, such search systems are constructed with the view that if terms exist within proximity to each other they must be related—but this is not always the case. In addition, such methodology is focused strictly on the relationship of the terms with respect to each specific document and cannot or does not permit a greater awareness of the relationship of the terms in a greater context.

Though perhaps an extreme example, the issues of determining the probable meaning of words is of great importance in disaster relief, Internet security, a parent is looking for safe birthday ideas for children, advice on nut allergies or other issues where misguided search or information resources could pose actual harm.

The frustrations with a single site are appreciated to compound when looking at multiple sites. A User who is qualified for a particular subject, say “marathons,” may be entirely new to a site and therefore even regular contributors may not recognize him or her, let alone appreciate that there are interests in common. Nor will this User be able to find the Entities i.e. other users, posts, discussions, groups, social media, or other communities, that suit his varying degrees of interest.

As technology evolves into machine learning, Artificial Intelligence, and user centric operating systems, services, marketing and more, there is an increased need for deeper understanding of conceptual meaning for users, groups, communities, information resources and other social objects such as pictures, videos or products, etc. To achieve a universal level of semantic analysis, which extends to multiple social network objects, calls for a decentralized (non-exclusive to a specific site) application for identifying the probable meaning of words as they relate to various social network objects. This way 3rd-parties can cater their applications, products, ads, searches, analytics, and more to what is deemed most meaningful across multiple Web resources through a singular application. In essence, the open-architecture of the Web requires a better standard for understanding meaning as it pertains to people and information resources in order to provide the right information to the right people at the right time.

A system that can recognize the probable meaning of words as they relate to different entities can improve upon the value of information while assisting in providing greater visibility, traction, and interconnectivity between people and information resources—hence, this system would serve the best interest of the people, groups, communities and organizations that use the Web. Contrarily, the lack of an authentic social standard for recognizing the meaning of words has resulted in misinformation, intrusive advertising, threats to privacy, and malicious behavior by unwanted, trolling individuals over open forums and online discussions.

Due to these concerns, the Web is still unsafe when it comes to the open social exchange of knowledge and information, therefore, private institutions such as enterprises, schools, universities, governments, or other organizations, are reluctant to embrace open social integration that would benefit their cause (i.e. research and development, training, education, job placement, cross-platform communication, community management, social integration, etc.)

Due to its open-source architecture, Web social organization is beyond the scope of conventional approaches to managing and organizing people and information resources, and this presents an extremely complex situation to the privacy and safety of the individual and online communities that want to utilize the social Web.

What is necessary is a systematic standard for understanding the meaning of words as they apply to the various social objects (i.e. the keywords, the people, their posts, the discussions, the communities, social media, etc.,) thus providing better understanding, management, and organization across the social Web.

Hence, there is a need for a method and system of determining semantics, or the probable meaning and/or context of words, in order to overcome one or more of the above identified challenges.

### SUMMARY

Our invention solves the problems of the prior art by providing novel systems and methods for determining semantics and the probable meaning and/or context of words.

In particular, and by way of example only, according to one embodiment of the present invention, provides a method to determine semantics, and the probable meaning and/or context of words as they relate to different Entities on at least one Social Network including: for a First Entity, gathering Metadata from at least one posting by a First User on a First Social Network to define at least one First Field associated with the First Entity, provided by the at least one First User and occurring in the at least one posting, each First Field associated with the First Entity having an initial system generated value; evaluating Responses to the posting by at least one Third Party, and in response to the Third Party using one or more of the First Fields associated with the First Entity in the Response, incrementing the value of each used First Field associated with the First Entity by the addition of a system generated value; and providing an indication of relevance for each First Field in relation to at least one Second Field associated with each First Entity, the indication of relevance permitting a determination of semantics for each associated Field of the First Entity.

In yet another embodiment, provided is a non-transitory machine readable medium on which is stored a computer program for determining similarities between Entities on at least one Social Network; the computer program comprising instructions which when executed by a computer system having at least one processor performs the steps of: for a First Entity, gathering Metadata from at least one posting by a First User on a First Social Network to define at least one First Field associated with the First Entity, provided by the at least one First User and occurring in the at least one posting, each First Field associated with the First Entity having an initial system generated value; evaluating Responses to the posting by at least one Third Party, and in response to the Third Party using one or more of the First Fields associated with the First Entity in the Response, incrementing the value of each used First Field associated with the First Entity by the addition of a system generated value; and providing an indication of relevance for each First Field in relation to at least one Second Field associated with each First Entity, the indication of relevance permitting a determination of semantics for each associated Field of the First Entity.

Still, in yet another embodiment, provided is a computer system having at least one physical processor and memory adapted by software instructions to determine semantics, and the probable meaning and/or context of words as they relate to different Entities on at least one Social Network including: at least one user account in the memory, the user account identifying at least a first Social Network and an associated known user identity; the processor adapted at least in part by the software as a Metadata gatherer structured and arranged to gather Metadata from at least the first Social Network regarding at least one First Entity, the gathered Metadata including at least one First Field obtained from at least one posting by a First User identity and subsequent third party Responses to the at First User identity; a database in memory structured and arranged to associate the at least one Field to the at least one First Entity; and the processor adapted at least in part by the software as a value determiner structured and arranged to evaluate Responses to the posting by at least one Third Party, and in response to the Third Party using one or more of the associated First Fields in the Response, incrementing the value of each used associated First Field by the addition of a system generated value, the value determiner further structured and arranged to provide indication of relevance for each First Field in relation to at least one Second Field associated with each First Entity, the indication of relevance permitting a determination of semantics for each associated Field of the First Entity.

### BRIEF DESCRIPTION OF THE DRAWINGS

At least one method and system for determining semantics and the probable meaning and/or context of words as they relate to different Internet Entities will be described, by way of example in the detailed description below with particular reference to the accompanying drawings in which like numerals refer to like elements, and:

FIG. 1 illustrates a high level conceptual view of the Semantic Determining System in accordance with at least one embodiment;

FIG. 2 is a flow diagram illustrating a method of semantic determination in accordance with at least one embodiment;

FIG. 3 is a conceptual illustration of a Discussion on a Social Network involving multiple Entities participating in semantic determination in accordance with at least one embodiment;

FIG. 4 is a conceptual illustration of a second Discussion on a Social Network involving multiple Entities participating in semantic determination in accordance with at least one embodiment;

FIG. 5 illustrates exemplary Database entries for at least a group of Entities involved in the Discussion shown in FIGS. 3 and 4 in accordance with at least one embodiment;

FIG. 6 illustrates exemplary Database entries combining Fields and Field Values for database tables shown in FIG. 5 in accordance with at least one embodiment;

FIG. 7 illustrates exemplary Database entries for at least a group of Entities involved in the Discussion shown in FIG. 3 in accordance with at least one embodiment;

FIG. 8 illustrates exemplary Database entries combining Fields and Field Values for database tables shown in FIG. 7 in accordance with at least one embodiment;

FIG. 9 is a conceptual illustration showing the identification of potential Entities of interest based on Field Relevancies in accordance with at least one embodiment;

FIG. 10 is an exemplary diagram of the social hierarchy of nested entities in accordance with at least one embodiment; and

FIG. 11 is a block diagram of a computer system in accordance with certain embodiments of the present invention.

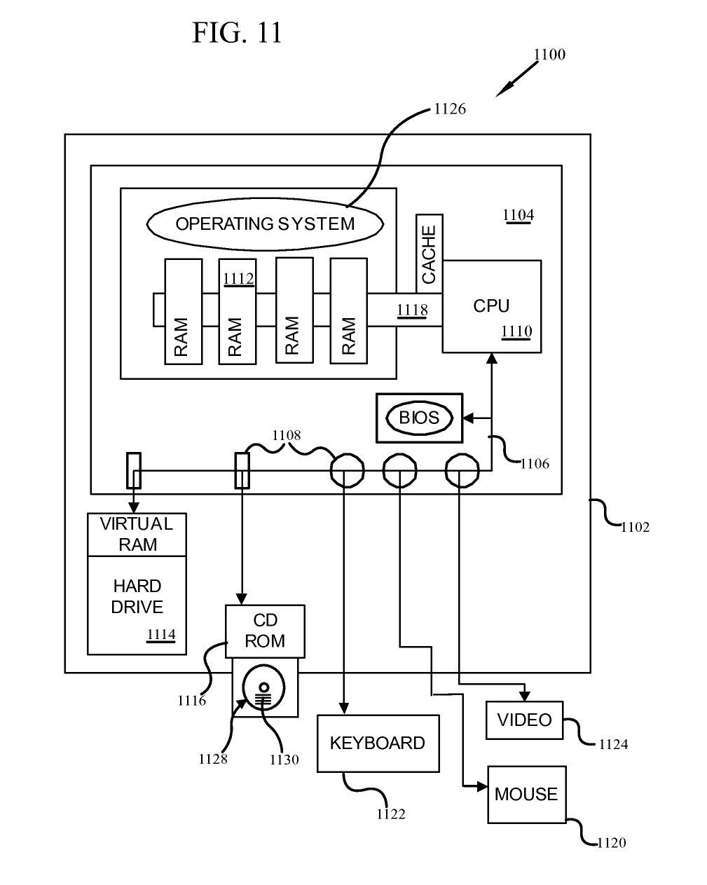

### DETAILED DESCRIPTION

Before proceeding with the detailed description, it is to be appreciated that the present teaching is by way of example only, not by limitation. The concepts herein are not limited to use or application with a specific system or method for determining semantics and the probable meaning and/or context of words. Thus although the instrumentalities described herein are for the convenience of explanation shown and described with respect to exemplary embodiments, it will be understood and appreciated that the principles herein may be applied equally in other types of systems and methods involving the determining semantics and the probable meaning and/or context of words.

To further assist in the following description, the following defined terms are provided.

“Social Network” as used herein is also understood and appreciated to be any online community platform where Users are identified by some form of User identification and make some level of exchange between themselves through Entry/Response. In other words a Social Network is appreciated to be any Internet based system that provides any form of media object (i.e., posts, blogs, articles, products, pictures, audio commentary, music, pictures video, responsive email, chat, etc. . . . ) that can be responded to by identified Users of that system. Moreover, in some embodiments the Social Network may be described as an online community platform. At times these online community platforms can contain sub communities within a parent community, such as in news media where a parent community might have different sections such as sports, politics, business, etc., or in an education setting where an online University may have different departments, courses, etc.

“Entity”—An Entity is recognized and defined by any social media object that can be associated with Fields and their Values that are generated through Users Entry/Responses in online Discussions. Typically, and reviewing from the bottom up, Social Network Users provide Posts as Entries/Responses that form Discussions and Discussions occur within Communities, and at times Communities can have Parent Communities. Each User, Post, Entry/Response, Discussion, Groups, Community and Social Network itself may be viewed as an Entity, with each higher order Entity (e.g., the Discussion), comprising lower order Entities (e.g., the Entries/Responses by Users). The arrangement of these Entities in relation to one another may be established differently for different embodiments. Likewise, community Entities can be the children of parent communities as is the case for an online classroom that is part of a department of a university. The Fields and Field Value of each higher order Entity is the result of the aggregation of all of its lower order Entities. For example: a Discussion's Field's and Field Values are the result of all Field and Field Values that arise from each User's Entry/Response within that Discussion. Determination of Similarity is made on an Entity to Entity basis where each Entity may be a high order or low order Entity. There are other forms of Entities, such as Interest Groups and even Fields, which are further defined below. It should also be noted that while a social media object, such as an Article, a Photo, a Song, a Video, an Advertisement, etc., can be considered Entities if they are directly related to a Discussion, in this regard the system treats each of these objects as the Discussion itself.

“3rd-party Entity”—Can be an advertisement, a publishing, a document, a product, a picture, a video, or any other Object that is defined by Metadata that can be used to extrapolate tags, keywords, key terms, phrases, text, etc., to establish similarities between Entities of the Semantic Determining System.

“User”—He or she who is providing the data in an Entry/Response. Users are also considered Entities based on the Field and Field Values they receive through online Discussion. Users may be human users engaged in active communication and Discussion over a Social Network and Users may also be automated systems that have been structured and arranged to engage with other Users in conversation.

“Community”—An Entity that relates to a forum or group of Discussions having at least one commonality. This commonality can be something as simple as the desire to share information over the Web, as with massive sized Social Networks. Communities can also be hierarchical and share something more specific, such as the class “Introduction to Physics” is a Community that is itself a sub-Community of the University providing the class. Likewise a section of a Social Network site dedicated to “Science” is a Community that is itself a sub-Community from the overall Social Network, and a sub-Community such as “Astronomy” or “Physics” may each be a sub-Community of the Science Community.

“Entry”/“Response”—An Entity that is defined by the data provided by a User in a Posting or in Response to a Posting on an Internet based Social Network site, and/or Community platform. For example, but not limited to, a post, article, tweet, instant message, chat, like, dislike, rating, product, picture, comment, email, instant message, or other indication or expression of an opinion of any separable Entity involved in the Web. Moreover, the data may be textual—as in a written comment, non-textual—as in a “Like” or a “Thumbs Up”, or a combination of textual and non-textual elements such as a textual Response that includes a rating scale. Since each Entry/Response may invite a tangent Discussion, each Entry/Response can also be considered its own Discussion.

“Non-textual Entry/Response”—A Posting that has limited or no text, as might be the case for a social media object such as an image, song, video, or a sign or symbol that relates to a rating such as a thumbs up/thumbs down, a 5 star scale, a like, a dislike, etc. In such a case the system can use the associated Fields of the parent Entity as the means for recognizing associations and valuing Fields from other Entities.

“Entry/Response Hierarchy”—The Entry/Response Hierarchy is defined through Entries and subsequent Responses that create threaded, or nested, Discussions that relate to specific topic of interest. Every time a new original Entry/Response is made, a new Hierarchy can be created and this begins a new Discussion. Since each Entry/Response may invite a tangent Discussion, each Entry/Response can also be considered its own Discussion. Every time an Entry/Response is made in relation to an existing Hierarchy, the Hierarchy is adjusted for that Entry/Response. The Entry/Response Hierarchy is used to define the levels of engagement in order to determine appropriate Field Value for branching out Discussions.

“Discussion”—Discussions are Entities started by and defined from Entries/Responses to those Entries. Through subsequent Response to an Entry the Entry/Response Hierarchy is generated based upon specific topics of interest and this results in a Discussion. Since each Entry/Response may invite a tangent Discussion, each Entry/Response can also be considered its own Discussion. Discussions are subjects that draw others Users to respond to the data posted by Users, and are defined by an initial entry, article, post, blog, tweet, instant message, chat, product, email, instant message or anything that can be responded to, rated, or commented on, that would start a threaded Discussion. Discussions can also relate to social media objects such as songs, pictures, videos, articles, etc. in order for the system to recognize these objects as their own Entities.

“Metadata”—This is data about data and relates to tags, or key words, key terms, or interests that are extracted and recognized within this system and method as Fields. Metadata can comprise one or more Fields. Metadata can be derived through blogs, postings, articles, songs, pictures, voice recognition, tags, etc. Indeed, the Metadata may be the data itself as directly provided by a User in an Entry/Response, an indicator such as a rating (like or dislike, thumbs up or thumbs down, etc. . . . ), and data associated with any form of an Entry/Response, such as but not limited to, the site IP, date, time, author, last editor, etc.

“Field(s)”—Are relational entities such as Metadata, tags, key words, or key terms as are commonly understood in searching and organizing data. Fields are defined from an Entry/Response through information generated from the information provided by the source of Entry and all Responses to that Entry. Fields can be generated by the 3rd-party Social Network, Users, or the Semantic Determining System itself. These may be one or more terms, the entire posting, parts of the posting, or a condensed version of the posting. Fields create universal Metadata that are specific to the Semantic Determining System and can be utilized across a plurality of Social Networks in order to recognize similarity between Entities. A Field can also be recognized as an Entity—as a Field builds associations to other Fields through their shared associations to other Entities. When matching Fields between Entities, the system can also determine similarities between non-identical Fields, therefore, a Field can be a pseudonym, abbreviation, or slang and still match a similar Field. For example: a term such as “Fished”, could be associated with “Fishing,” or “‘Fins” could be associated with “Dolphins,” or “MJD” could be associated with a famous football player named “Mourice Jones-Drew,” etc. Also, the comment “I like him too” could refer to a previously identified Field that relates to a person.

“Field Value”—Is the value applied to a Field. Moreover, a Field in a new original Entry, or a new Field to an existing Discussion has no Field Value, or a Field Value of 1. As discussed below, for at least one embodiment Field Value is based on the frequency of Responses overall, where the Response is located in the Entry/Response Hierarchy, the Ratings from those Responses, as well as the frequency of Field usage in subsequent Responses. The overall Field Value applied to a User or Entity in Association to a Field is the aggregate of all Field Values defined through Discussions that relate to that Entity.

“Field Relevance”—The relevance of one Field to another is determined in the context of Field Values established for an Entity. Moreover, as is shown below, an Entity such as a User will establish a group of Associated Fields each having a Field Value, and collectively these Field Values providing a range. The relevance of one Field to another will fall within this range, and a higher degree of relevance is understood where the Field relevance is towards the higher end of the range and a lower degree of relevance is understood where the Field relevance is towards the lower end of the range. The Field Relevance is not an absolute certainty, but rather is an indicator of probable relevance.

“Interest Group”—A grouping of two or more Fields and their values which can be defined by the Semantic Determining System or an Entity such as a User or a Community. Since Interest Groups are comprised of Fields and Values they are also considered an Entity. Interest Groups provide more accurate similarities based on the number of Fields it provides for matching similarities between Entities. For example: a User could create an Interest Group called “Surfing California” and include the Fields “Surfing,” “California,” “Beaches” and this would create more accurate similarities between Entities that share these same levels of interest. Likewise Interest Groups can assist by providing greater accuracy in determining similarities between entities. They can also be used for visibility and privacy settings between entities.

“Semantics”—The meaning and/or relationship and/or context between terms in free-form language input such as text or speech. Many words can and often do have multiple meanings, and the correct identification of the intended meaning and/or context is not likely based upon the term itself taken in isolation, but rather in how the term is used in relation to other terms. For example “board”—it can be a verb as in “to board a plane” or a noun, “I have my board, lets surf!” the second example also suggesting that “board” may be short for “surfboard.” As used herein, the semantics of a term are not intended to imply that the entire meaning and/or context of an entire sentence or statement is to be understood. Rather semantics as used herein is the effort to identify correlations between different terms—in the context of a Discussion or chat group regarding surfing, is “board” more likely to be a “surf board” or the action of getting on a plain or train. Through the ability to establish value for term—i.e., key terms or Fields, and then compare the values of these terms in relation to other terms with established value to appreciate Field Relevance, the probable semantic meaning of each term in relation to other terms is advantageously viable.

In other words, semantics is understood to be determined both by the appearance of common Fields between one or more Entities, and also how the Fields relate to one another within their association to each Entity. More specifically, the Fields “Beach” “California” and “Surfing” have a degree of relevance as they apply to an Entity such as a User, a Post, a Discussion, a Group, or a Community, and therefore, the Field “surfing” shares a certain degree of meaning with the Fields “Beach” and “California” for each Entity. Yet another Entity having only the Fields “Beach” and “California” of dissimilar values may indicate that these Fields are not used in the same context or frequency, nor do they show relevance to the word “Surfing” within the context of that Entity. Indeed the Semantic Determining System 100 does not merely query for similarities between terms, but assists in understanding the similarities between terms as they relate to different entities. This results in a variety of options for determining the probable meaning and/or context of words as they relate to different contexts.

Moreover, for at least one embodiment, the Semantic Determining System has the ability to define the probable meaning and/or context of words as they relate to various Entities. These Entities may exist in higher or lower levels of order. For Instance, a User's post is of lower level of order than the Discussions itself. Likewise a User is of higher level of order than the posts, i.e. a User can have many posts, while the Community itself is of higher level of order than the Discussion. Levels of order allow the Semantic Determining System to use multiple perspectives to identify semantics between various entities. If the probable meaning and/or context of a word cannot be determined through the relevance between terms in a post, then the Semantic Determining System can revert to the User, the Discussion, or the Community to recognize the probable meaning and/or context of words as they relate to a lower level Entity such as a post.

By implication, a 3rd-party application, such as an advertisement, a publishing, a market analysis, a search, a product, an assessment of text or data, etc., can also utilize the Semantic Determining System to determine the probable meaning of words in various contexts. In such a case, words that identify these 3rd-party Entities, can be associated to words that identify Entities which are defined by the Semantic Determining System, in order to establish meaningful relationships between these Entities.

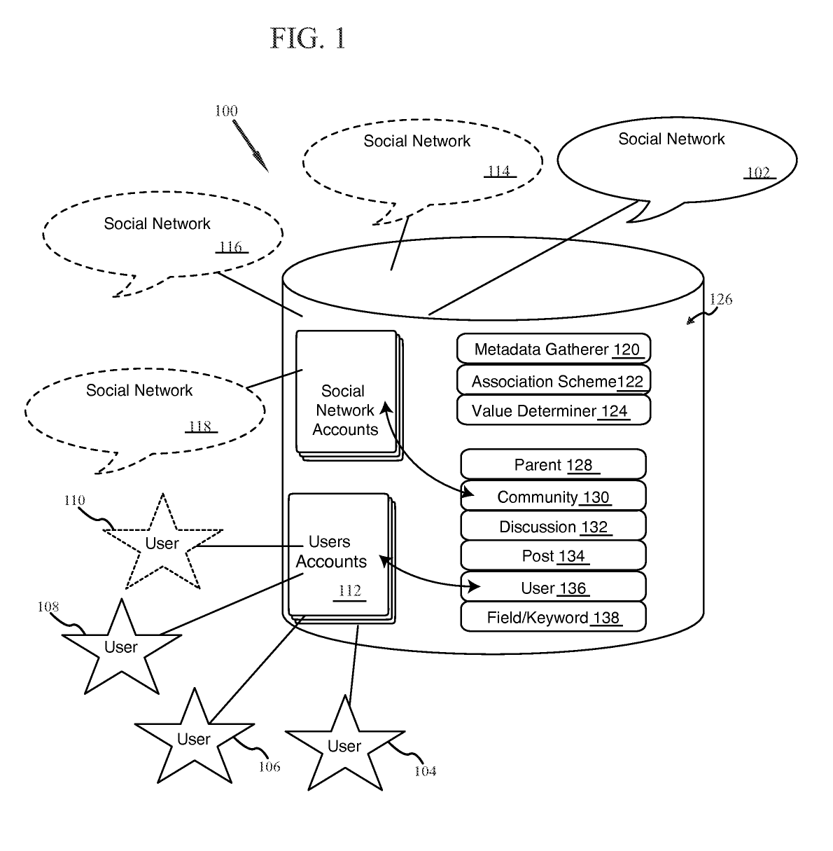

Turning now to the figures, FIG. 1 is a high-level block diagram of an embodiment of the Semantic Determining System 100. As shown the Semantic Determining System is in communication with a first Social Network 102, and at least one or more Users, of which Users 104, 106, 108 and 110 are exemplary. In at least one embodiment, the Semantic Determining System 100 is a component of the first Social Network 102

The first Social Network 102 and the Semantic Determining System 100 are understood and appreciated to be one or more computer systems, (including microprocessors, memory, and the like) adapted at least in part to provide the first Social Network 102 and the Semantic Determining System 100. More specifically each may be a general computer system adapted to operate as a Social Network, such as first Social Network 102 and/or the Semantic Determining System 100, or a specialized system that is otherwise controlled by or integrated with a computer system.

For such embodiments, Users 104, 106, 108 and 110 may be identified as known or registered Users on the basis of having established accounts with the first Social Network 102. In such embodiments, the Users of the first Social Network and more specifically the Semantic Determining System 100, may not need to provide additional information to the Semantic Determining System 100 to permit monitoring and determination of similarity to occur as their respective associated User Identities are already known as are the parameters of the first Social Network 102.

In varying embodiments, Users 104, 106, 108 and 110 may become known or registered Users by establishing User Accounts 112 directly with the Semantic Determining System 100. For embodiments wherein the Semantic Determining System 100 is in communication with a plurality of Social Networks, e.g., first Social Network 102 and one or more second Social Networks 114, 116 and 118, additional access information for all of Social Networks may be provided by each User in his or her User Account 112.

In addition, each User Account 112 may define one or more User Identities that are associated with the known User in various different Social Networks. Moreover, for at least one embodiment, the User Accounts 112 define for the Semantic Determining System 100 the User Identities to be monitored, evaluated, authenticated and reviewed for similarity with other Entities upon one, or across many, Social Networks.

In at least one alternative embodiment, the Semantic Determining System 100 is distinct from the Social Network 102. Further, whether a component of the first Social Network or distinct from the first Social Network, in varying embodiments the Semantic Determining System 100 is also in communication with a plurality of second Social Networks, of which second Social Networks 114, 116 and 118, are exemplary.

To facilitate this, in at least one embodiment, the Semantic Determining System 100 has a Metadata Gatherer 120, an Association Scheme 122, a Value Determiner 124 and a Database 126 which is comprised of a collections of Entities as further described below.

Moreover, the Metadata gatherer 120, association scheme 122, value determiner 124, and database 126 may be established by software provided to adapt a general purpose computer having at least one processor to perform these specific rolls, or each may be a dedicated system operating in consort to provide the Semantic Determining System 100.

To summarize, for at least one embedment, the Semantic Determining System 100 is a computer system having at least one physical processor and memory adapted by software instructions to determine semantics, and the probable meaning of words as they relate to different Entities on at least one Social Network. This system, adapted by the software has at least one User account in the memory, the User account identifying at least a first Social Network and an associated known User identity. The processor is adapted at least in part by the software as a Metadata gatherer structured and arranged to gather Metadata from at least the first Social Network regarding at least one First Entity, the gathered Metadata including at least one First Field obtained from at least one posting by a First User identity and subsequent third party Responses to the at First User identity. A database is also established in the memory and structured and arranged to associate the at least one Field to the at least one First Entity. The processor is further adapted at least in part by the software as a value determiner structured and arranged to evaluate Responses to the posting by at least one Third Party, and in response to the Third Party using one or more of the associated First Fields in the Response, incrementing the value of each used associated First Field by the addition of a system generated value, the value determiner further structured and arranged to provide indication of relevance for each First Field in relation to at least one Second Field associated with each First Entity, the indication of relevance permitting a determination of semantics for each associated Field of the First Entity.

For at least one embodiment, the Semantic Determining System 100 is a an adaptation of U.S. Pat. No. 8,806,598 filed on Sep. 21, 2011 as application Ser. No. 13/239,100 and entitled “System and Method for Authenticating a User through Community Discussion” and/or U.S. application Ser. No. 13/709,189 filed Dec. 10, 2012 and entitled “System and Method for Determining Similarities Between Online Entities,” each incorporated herein by reference.

More specifically, U.S. Pat. No. 8,806,598 teaches at least one system and method for assigning value to Fields occurring in an online Community Discussion. The specification of '598 teaches this process in detail. To summarize, value for one or more terms, i.e. Fields associated with a User and occurring in a post or Discussion involving the User is system generated in Response to subsequent use of those terms by third parties who are responding to User. In other words, the value is built through Discussion. This process is non-subjective as the system value is assigned and accumulated based upon subsequent use not the subjective views of the third party.

Application Ser. No. 13/709,189 draws upon the development of value as established by U.S. Pat. No. 8,806,598 and applies the developed values for associated Fields to determine similarities between entities based on Fields associated with each Entity and the values of those Fields.

For the present application, the Value Determiner 124 is substantially the authenticator as set forth and described in U.S. Pat. No. 8,806,598, and for the sake of application Ser. No. 13/709,189 this valuation and authentication process is extend to other Entities, not just to Users, but to their posts (i.e. Entry/Response) the Discussions, the Communities, the Social Network and other Entities that relate to the source of authentication described in application Ser. No. 13/239,100, now U.S. Pat. No. 8,806,598.

For the sake of this application, the valuation and authentication process, as it is based in the definition of Fields for each Entity, allows for an understanding of relevance—i.e. semantics—between Fields as they relate to each Entity. This ability to understand the relevance of Fields for each Entity, allows for the probable meaning of words between all Social Network Entities defined and implied in U.S. Pat. No. 8,806,598 and U.S. application Ser. No. 13/709,189 and can be offered to 3rd-party Entities that exist outside the Similarity Determining System yet utilize its semantic benefits.

As is further discussed below, the Database 126 is structured and arranged to establish and maintain the Entry/Response Hierarchy. More specifically, the Database 126 is structured and arranged to track and determine the relevance of Fields as compared to other Fields, and as they relate to different Entities, such as but not limited to the Social Network (i.e., a parent Entity or senior Entity), the Community, the Discussion, the Group, the Posts (i.e. Nested Junior Entities), and each User engaged in the Discussion. Moreover for each potential Entity as defined for an instance of the Semantic Determining System 100, the Database 126 provides collections of Fields, such as the Parent Collection 128, the Community Collection 130, Discussion Collection 132, Post Collection 134, User Collection 136, Field/Keyword Collections 138, and/or other Entity collections, not shown. Of course, within each collection there may be sub-collections, such as the Discussion Collection 134 having internal collections for each Entry/Response.

The Metadata Gatherer 120 in connection with the information provided in the User Accounts 112 monitors Community activity within at least the first Social Network 102. When any User established with the Semantic Determining System 100 makes an Entry or Response, the Semantic Determining System 100 gathers, via the Metadata Gatherer 120, appropriate data from the Entry or Response and the subsequent Responses. This includes attributes such as date and time, User name, message content, message title, tags, key words, ratings information, etc. . . . Moreover, the data from the Entry or Response may be any data associated with the Entry or Response—that is provided directly as the textual or non-textual Entry or Response or that is supplementary to the Entry or Response.

In at least one embodiment, the gathered Metadata will include at least one Field obtained from at least one posting by a known User identity and subsequent third party Responses to the known User identity. The Database 126 is structured and arranged to record the association of at least one Field to the known User identity. For embodiments where the User Account 112 are not specifically maintained by the first Social Network 102, the Database 126 may further be structured and arranged to maintain the User Accounts 112 as well.

As is further explained below, for at least one embodiment, if the Semantic Determining System 100 determines that the User posting the Entry/Response is not a known or registered User, the Semantic Determining System 100 may invite the User to become a registered User and therefore also enjoy the benefit of the system. For yet other embodiments, the User posting the Entry/Response need not be a known or registered User for the value of one or more Fields to be increased and the determination of semantics thereby improved.

Metadata, tags, keywords, key terms phrases or any form of text, generated from the Entry/Responses become Fields and permit the Semantic Determining System 100 to establish relationships between other Entities through associations to Fields derived from the Entry/Responses within the Discussion. Data generated from non-registered Users enters the Entry/Response Hierarchy in order to maintain the flow of Discussion in relation to topic of interest. However, in at least one embodiment as the User is not a registered User, the entry of the data does not create associations or Field Values related to the unregistered User.

In another instance if an unregistered User can be identified through a unique identifier such as an email address, password, or unique User name, then the non-registered, identifiable Users, their associated Fields, and the values of these Fields, can be determined and sent to a temporary Database location. If this User decides to become a registered User of the system, these Fields and their values can be immediately updated to their profile after proof that they are that actual User.

The Association Scheme 122 recognizes the Associations between an Entity, such as for example the registered Users, and associated Field(s). This recognition is based on the developed values of the associated Fields and the ability to thereby compare the developed value of the associated Fields to each other. More specifically, the Semantic Determining System 100 builds an aggregate of associations based upon frequency and usage of specific Fields per Entry/Responses by each User. As the Fields are tracked with respect to the developing Entry/Response Hierarchy the Users who engage in the Discussion, their Entry/Response, the Discussion itself, and the Community in which the Discussion is occurring, each of these Entitles may be ascribed an associated value for each Field.

Indeed the arrangement of Entities for a Social Network is understood and appreciated to be a nested association. There are Users who participate in Discussions, and these Discussions may appear under a Community, etc. . . . Of course the order of the nesting and the distinct labels applied to each Entity may vary from one embedment to another. It is also to be understood that higher order entities assume the values for associated Fields that are established with respect to their lessor nested Entities. In other words, Users develop associated Fields that develop value through their participation in a Discussion. Each User has his or her own set of Associated Fields, but within the context of that particular Discussion, the Discussion as an Entity assumes the valuations from the Entities below it, i.e., the Users participating in the Discussion. The Community as an Entity likewise assumes the valuations from the Discussions below it, and so on and so forth.

Of course it will be appreciated that higher order Entities may see an aggregation of identical Fields—for example a first User's Entry/Response may have an associated Field, “Marathons,” with a developed point value and a second User's Entry/Response may also have an associated Field, “Marathons,” with a developed point value. As both the first User's Entry/Response and the Second User's Entry/Response are part of the same Discussion, called “Disney Marathons” the Discussion Entity “Disney Marathons” receives value for the Field “Marathons” from both the first and second User's Entry/Response. The aggregation of value is specific to Users Entry/Response, which aggregate into the value for the Discussion, the Community, and any parent Communities that may exist. Therefore, the relevance between Fields of lower level Entities will eventually dictate the relevance of Fields for higher level Entities.

Associations between Fields can be made based on exact terms, similar terms, or terms that are considered relative to one another based upon the Semantic Determining System. For instance, a nickname for a person can match the person's real name (“Mrob”=“Michael Robinson”) through the Semantic Determining System's ability to recognize relevance between Fields that relate to multiple Entities and their associated values when compared. Of course the Users can also specify at the time of their posting that Mrob is a nickname for Michael Robinson. Also, the comment “I like that as well” or “I like him too” could be associated with a Field from a previous post.

It should also be appreciated that matching Fields between Entities can also occur through matching non-identical Fields—for example, when matching Fields between Entities, the system can also determine relevance between non-identical Fields that share meaning. In this regard, a Field can be a pseudonym, abbreviation, or slang of a matching Field. For example: a term such as “Fished” could be associated with “Fishing,” or the term “Fins” could be associated with “Dolphins,” or “MJD” could be associated with a famous football player named “Mourice Jones-Drew.”

For at least one embodiment, Semantic Determining System 100 is also structured and arranged to recognize related Fields based on one being a component of the other, i.e., “Board” for “Surfboard” where both Fields accumulate value in the context of a Discussion about “Surfing” and “Beaches.” Similarly “MJ” may be identified as a nickname for “Michael Jordan” based on the two capital letters matching to the letters of the first and last name, the Fields of “Michael Jordan” and “MJ” having accumulated comparable values in a Discussion regarding “Basketball.” And of course, as Users are permitted to indicate Fields, for at least one embodiment, Users may indicate that one or more Fields are equivalent to each other as having the same meaning.

For a non-textual Response, such as a thumbs up, like, or recommend, if there is no way to determine Fields through the lack of Metadata, then a the system can revert to the Fields of the parent Entity, such as the User Collection 136, in order to identify Fields that relate to that User and utilize these Fields for association between Entry/Response.

These Fields and their associated Field Values determine the relevance between other Fields and is indicated to Users and other Entities of the Semantic Determining System 100. For example, the probable meaning of words can be indicated through a popup or hovering window that provides at least a partial listing of the relevance of Fields to one another, or through providing a list of the most relevant Fields that relate to different Entities, such as a User, a Discussion, a Community, etc. As Fields, and their values, are also compared for the relevance between one another, they provide a context for determining the relevance between Entities. This would direct a User to a Discussion, Community, picture, product or video that shares the same degree of relevance between Fields, even if these Fields do not directly match. Moreover, the context of relevance for at least one embodiment is determined by comparing the values of each Field and determining a relevance—such as in ascending or descending index order. Fields that have a higher level of relevance have a stronger context of association as compared to Fields that have a lower level of relevance.

As mentioned before, for non-textual Responses Fields from parent Entities can be used to define Fields for a non-textual Entity, such as a “thumbs up” post, a “like”, or a “share,” or a star rating. Moreover, as the Field Value is determined by subsequent Responses, whether textual or non-textual, a variety of different methodologies for determining Field Value may also be adapted and employed.

In one method, if a Field cannot be determined through the Metadata from a non-textual Entry/Response, then the system can identify associated Fields from other higher level Entities such as the User who posted the non-textual Response, or from other related Entities such as the Discussion, or the Community to which the Post belongs. For example, if a User “thumbs up” an article on surfing, even though the Response “thumbs up” did not include the Field “Surfing,” if the User Entity has an association to the Field “Surfing” then an association can be made between the two Entities. Likewise, if every Response is a non-textual Response, the system can evaluate Fields associated with parent Entities, i.e. the Users, the Group, the Community, etc., can be associated to the Entities that relate to that Post.

As is the case for matching Entities that do not include any Fields, such as a Post without a Response, the system can utilize the Fields of other related Entities, such as the User, the Discussion or the Community, to which the Post belongs to, in order to recognize association and establish valuation. This is the case only as long as the higher-level Entity has already established an association to one or more Fields and a Value for those Fields.

Where the Semantic Determining System 100 is in communication with a plurality of Social Networks, such as Social Networks 114, 116 and 118, this reference of association permitting a determination of similarity is viable across the plurality of Social Networks with respect to different Entities.

With respect to FIG. 1, it is understood and appreciated that the elements, e.g., Metadata Gatherer 120, the Association Scheme 122, the Value Determiner 124 and the Database 126 are in one embodiment located within a single device, such as for example a computer. In at least one alternative embodiment, these elements may be distributed over a plurality of interconnected devices. Further, although each of these elements have been shown conceptually as an element, it is understood and appreciated that in varying embodiments, each element may be further subdivided and/or integrated within one or more elements.

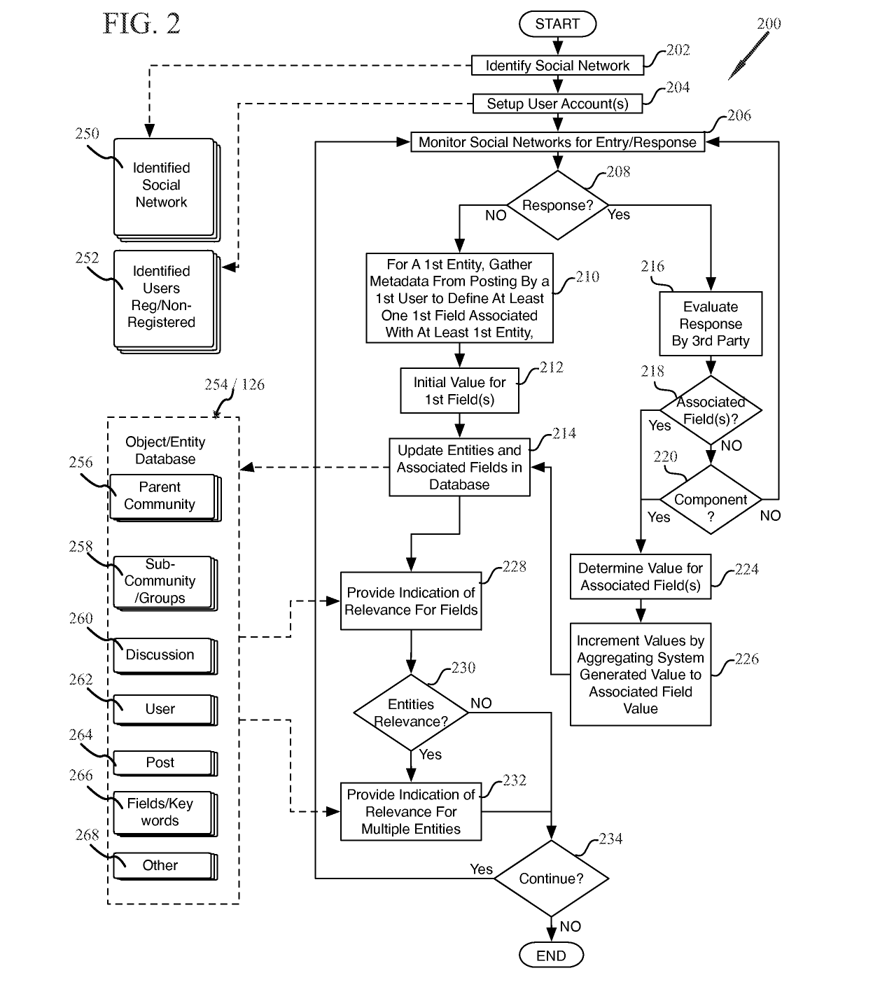

FIGS. 2-9 provide a high level flow diagram with conceptual illustrations for Discussions upon an exemplary Social Network site, e.g., first Social Network 102, and subsequently at least one additional Social Network site, e.g., second Social Network 104. It will be appreciated that the described events and method need not be performed in the order in which it is herein described, but that this description is merely exemplary of one method of implementing a method to achieve the Semantic Determining System 100, or more specifically a method of determining relevance, or meaning, between Fields as they relate to different Entities upon one or a plurality of Social Networks.

In addition, for ease of illustration and Discussion the use of textual Discussions have been shown, however it is to be understood and appreciated that other options for media, such as but not limited to one or more pictures, movies, videos, audio files, songs, or even links to other media may be used at least as part of the initial posting. Often, with such media, there is also a clearly identified subject—such as a caption, title, or a transcript. When this exists, the subject is recognized by the Semantic Determining System 100 and method 200 as the original Entry/Response and therefore regarded as a Discussion.

Moreover, if the nature of the Discussion is such that a title is clearly provided, the Semantic Determining System 100 and method 200 accept that as the title of the Discussion. Of course for the determination of relevance between Fields, a title is not specifically required, though certainly it may be helpful. If the nature of the Discussion is such that a title is not clearly provided, the Semantic Determining System 100 and method 200 may simply focus on the associated Fields defined within the first level Entry/Response or through recognizing a string of initial characters of that Discussion as its title.

It is also understood and appreciated that the methodology of determining relevance may take many forms. The total number of Responses to an initial posting may be simply tallied, direct Responses may be valued differently from indirect Responses, the time between posts and Responses may be accounted for and used to reduce the accumulated values of Fields over time, etc. Moreover, different methodologies for valuation may also be established for different embodiments of Semantic Determining System 100. With respect to the Discussion herein, it is understood and appreciated that the description of determining relevance is merely exemplary of one method of operation in accordance with the present invention, and not a limitation.

The Semantic Determining System 100 is, as noted above for at least one embodiment, implemented to provide a determination of relevance for Fields that relate to different Entities, and therefore determines a level of relevance between Entities as well, across a plurality of Social Networks. It is understood and appreciated that even where multiple Social Networks are involved, determination of relevance can and does occur on individual Social Networks.

As such, in the following description the methodology for determination of relevance between Fields and Entities is presented with respect to one Social Network, e.g., first Social Network 102, before demonstrating how the determination of relevance may be expanded across multiple Social Networks.

With respect to FIG. 2, in addition to illustrating the steps of the method 200 there is an attempt to further illustrate in general which elements of Semantic Determining System 100 are in play at different stages. Accordingly along the left side of the flow diagram is presented a conceptualization of the Social Network(s) 250, the Users 252, and the database 126—more specifically the Field/Entity Database 254, shown to include at least one or more entities of the type for a parent Community 256, a Community 258, a Discussion 260, a User 262, a post 264, Fields/keywords 266, and an other 268. Of course this listing is merely exemplary for a conceptual Semantic Determining System 100 and method 200 and not a statement of limitation. Indeed greater or fewer and different entities may exist in different embodiments as appropriate for the situation of implementation.

As shown in FIG. 2, the method 200 commences with affiliating at least one Social Network, block 202. For an embodiment where the Semantic Determining System 100 is implemented directly as a component of a Social Network, such as first Social Network 102, the Users of the first Social Network may all be identified as known or registered Users with no further action.

For at least one alternative embodiment, whether integrated as a component of the Social Network or not, a User sets up his or her account and provides at least his or her associated User identity and such other relevant information regarding the Social Networks he or she uses, block 204.

With respect to the Database 126 shown as database 254, FIG. 2 illustrates that, for varying embodiments, the Database 254 receives and records the basic information, such as affiliated Social Network(s) (records of affiliated Social Network(s) 250), a listing of registered or known Users (records of registered Users 252), and a listing of each User's Social Network(s) (records of Social Networks affiliated with Users 252). These records may certainly be combined, but have been shown distinctly for ease of Discussion.

The Semantic Determining System 100 then commences to monitor the specified Social Network or networks awaiting action by a registered User, block 206. For at least one embodiment, there may be Users who are not registered Users of the Semantic Determining System 100, (not shown). For at least one embodiment, if the initial activity is by an unregistered User these initial postings by such unregistered Users are ignored, and the Semantic Determining System 100 remains in a monitoring state, (not shown.)

For at least one optional embodiment, postings by un-registered Users are trapped to initiate an offering for these Users to become registered Users, (not shown.) This may be accomplished by initiating a new pop-up, application or appliance that informs the User of the presence of the Semantic Determining System 100, its function, features and benefits and how determination of similarity achieved. His or her Entry/Response may also be cached, (not shown) during this account set up process so that upon enrolling in the Semantic Determining System 100 he or she is given immediate credit for his or her Entry/Response.

If the un-registered User accepts the offer to become a registered User, he or she is then directed to the process of setting up his or her account, (not shown.) Of course, if he or she opts not to accept the offer to become registered, the method continues and the un-registered User is simply treated as an un-registered User.

In certain embodiments, Responses by un-registered Users can be used in building Field Value, the values subsequently used in the determination of relevance.

Returning to method 200, for ease of Discussion, it is assumed that the User is a known User who is initiating activity. Method 200 then queries to see if this is the first post indicating a new Discussion, or a Response to an existing post in an existing Discussion, decision 208. As noted above, and taught by U.S. Pat. No. 8,806,598, non-subjective valuation of Fields is established through subsequent Responses by third parties. As such, if the post is determined to be a post for a new Discussion, then initial Fields associated with at least one First Entity should be established.

Moreover, if the posting is not a Response, decision 208, method 200 branches to establishing for at least one First Entity, gathering Metadata from the posting by a first User on a First Social Network to define at least one Field associated with the First Entity and provided by the First User, block 210. For each First Field associated with the First Entity, an initial system determined value is applied, block 212. The database is then updated to reflect the new at least one First Field and it's Field value as associated with at least the First Entity, block 214.

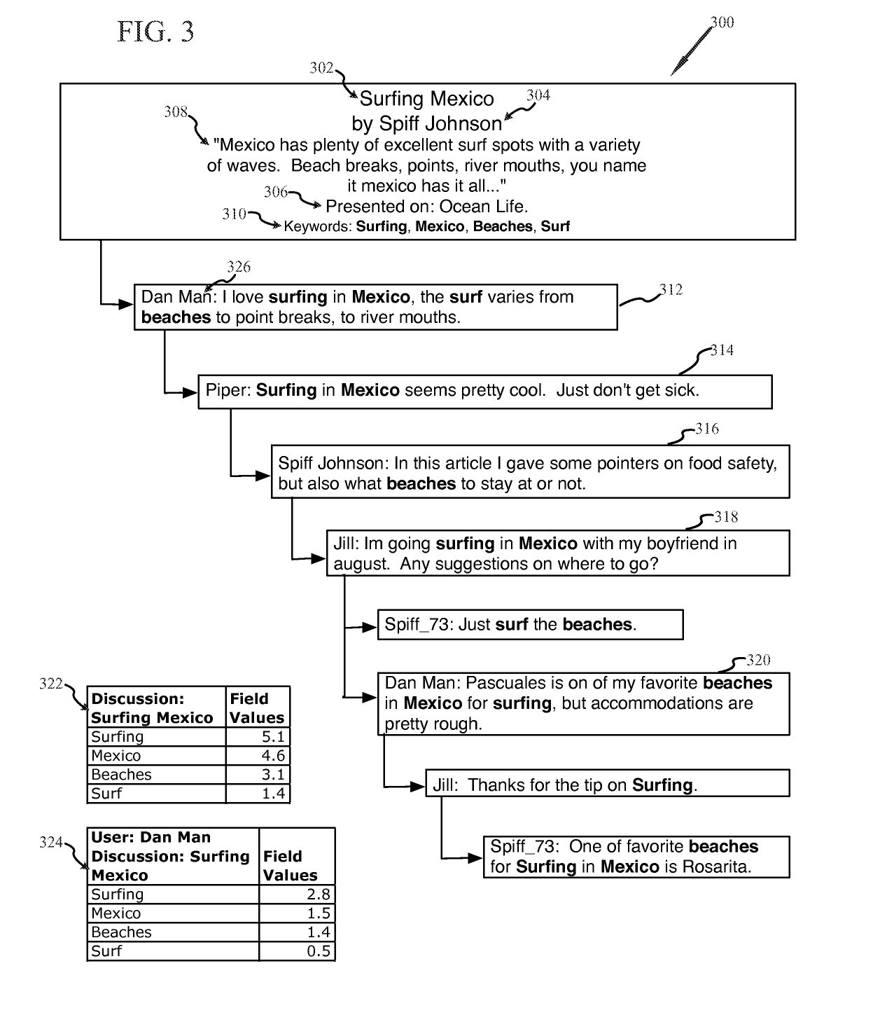

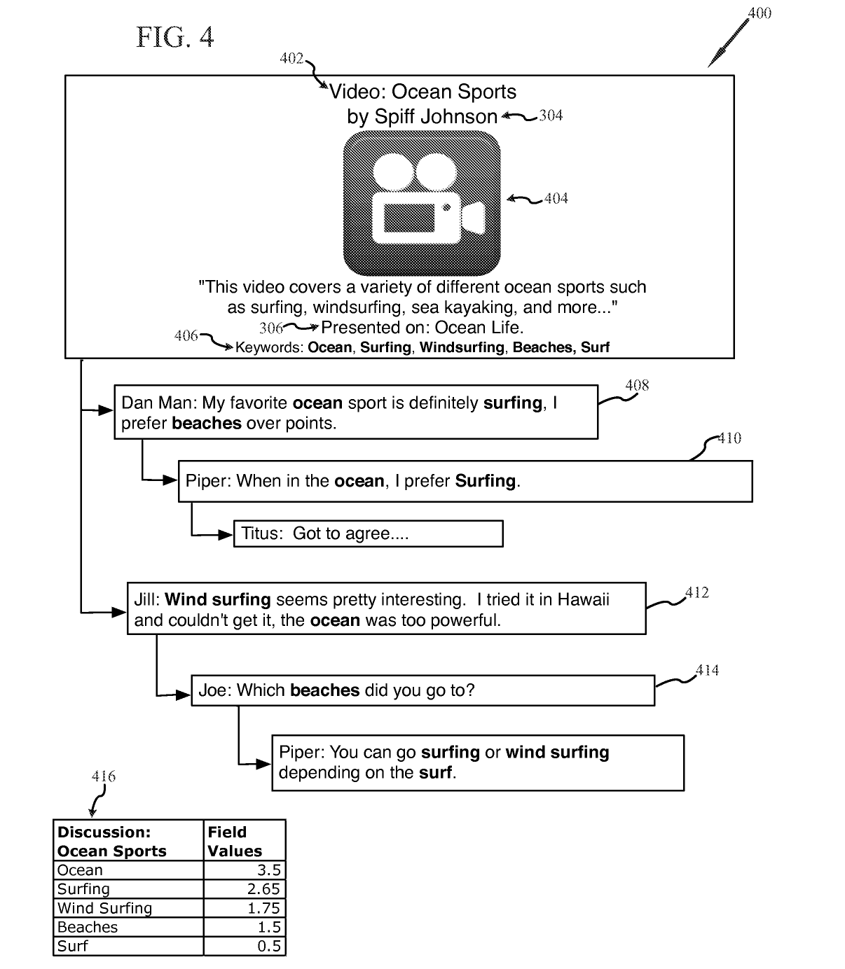

FIGS. 3 and 4 are conceptual Discussions provided to assist with understanding and appreciating method 200. As noted above an Entity may be any of a number of different actors including Users and the Discussion itself. Moreover the First Entity may be the Discussion itself, i.e. Discussion 300, or First Entity may be the First User who initiates the new Discussion. Indeed there may be many First Entities wherein a Second Entity may be further defined to be another of the First Entities such that a comparison between them can be made.

FIG. 3 is a conceptual illustration for a Discussion 300 called Surfing Mexico 302 that has been created by User Spiff Johnson 304, which is occurring over the online Community Ocean Life 306. Moreover these Entities are nested entities—Online Community Ocean Life 306 is the most Senior Entity suggested by FIG. 3, the Discussion Ocean Life 306 is the next lower Entity and Spiff Johnson 304 is the next lower Entity. For at least one embodiment, the additional Users and even the Posts themselves are additional lower level entities.

From an opening post 308 provided by Spiff Johnson 304 a plurality of Fields have been established and associated with at least a First Entity, i.e., the Discussion Surfing Mexico 302. These associated Fields 310 are shown as keywords—specifically Surfing, Mexico, Beaches, and Surf. A plurality of Responses to the initial posting are also shown, such as for example Responses 312, 314, 316, 318 and 320. For each of these Responses the Fields 310 (keywords) used have been highlighted for ease of identification.

In a similar conceptualization, FIG. 4 presents a Discussion 400 called Ocean Sports 402 that has been created by Spiff Johnson 304, which is occurring over the online Community of Ocean Life 306. Moreover these Entities are nested entities—Online Community Ocean Life 306 is the most Senior Entity suggested by FIG. 4 and is the same senior Entity suggested in FIG. 3. The Discussion Ocean Sports 402 is the next lower Entity and Spiff Johnson 304 is the next lower Entity. For at least one embodiment, the additional Users and even the Posts themselves are additional lower level entities.

From an opening post 404 provided by Spiff Johnson a plurality of Fields have been established and associated with at least a First Entity, i.e., the Discussion Ocean Sports. These associated Fields 406 are shown as keywords—specifically Ocean, Surfing, Windsurfing, Beaches, and Surf. A plurality of Responses to the initial posting are also shown, such as for example Responses 408, 410, 412 and 414. For each of these Responses the Fields 406 (keywords) used have been highlighted for ease of identification.

Again, as noted above, an adaptation of U.S. Pat. No. 8,806,598 and/or U.S. application Ser. No. 13/709,189 permits each associated Field to non-subjectively develop value based on subsequent use in direct and/or indirect Responses.

Indeed as shown in FIG. 3, all of these Fields 310 when associated with the Discussion 300 Surfing Mexico 302 have a developed Field value as shown in conceptual Field Value table 322. Each User participating in the Discussion 300 may also have established associated Fields 310 with respective Field values as well. For example, table 324 is shown to illustrate the Fields 310 and Field values established for User Dan Man 326.

Likewise all of these Fields 406 when associated with Discussion 400, specifically Ocean Sports 402 have a developed Field value as shown in conceptual table 416. It is also of course understood and appreciated that these Fields may also be associated with each of the different users and for each User the associated Fields will also develop value, although likely different for each User. Indeed, the user Dan Man 326 seen in FIG. 3 is also an active user shown in FIG. 4. As in the example shown in FIG. 3, the Fields associated with Dan Man 326 are also generating value with respect to his participation in the Discussion Ocean Sports 402, and this generated value is aggregated with his associated Fields and Field values on the whole as a User. Indeed his participation in multiple Discussion helps establish greater Field values and greater Field relevance.

Returning to FIG. 2 and method 200, if the posting is a Response, decision 208, method 200 branches to evaluate the Response as provided by the third party, block 216. More specifically this evaluation includes gathering information, including Metadata from the Response. With respect to textual Responses, a query is performed to check each Response for the use of one or more of the Associated Fields, decision 218.

As noted above, for at least one embodiment, Semantic Determining System 100 is structured and arranged to identify related Fields based on one being a component of the other, i.e. “board” for “surfboard” or “MJ” based on the capital letters in the name “Michael Jordan.” As such, for at least one embodiment, method 200 includes the optional query to review the posting Response for Fields identified as components of other Fields, decision 220.

Moreover, the User, Community administrator, or system itself may define component groups or semantic groups based on at least two Fields that relate to a parent Field. For example, a Community administrator could build a semantic group and define the parent Field to be “Michael Robinson” after an NFL football player. The administrator can then group all other Fields for the Community Entity that are pseudonyms or nicknames of Michael Robinson, such as “Mrob” “Mike Rob” “M Robinson” etc. The grouping of these pseudonyms allows for a more accurate and combined understanding of the various Fields, which all mean the same thing and relate to a single parent Field “Michael Robinson”.

Where the Response is determined to have at least one associated Field in use, method 200 determines a non-subjective value that is to be added to the Field value of each of the associated Fields used, block 224. This value is then added so as to increment the Field values of the associated Fields, block 226. Moreover, the Field values are incremented by aggregating system-generated value to the associated Field value of each Field used in the Response.

With these values so determined, method 200 then returns to update the Entities and associated Fields in the database, block 214. For at least one embodiment, if a new component Field has been identified or otherwise provided by a User, this new component Field is added to the database as well and may be further cross indexed to its parent term, i.e., “board” cross indexed to “surfboard.”

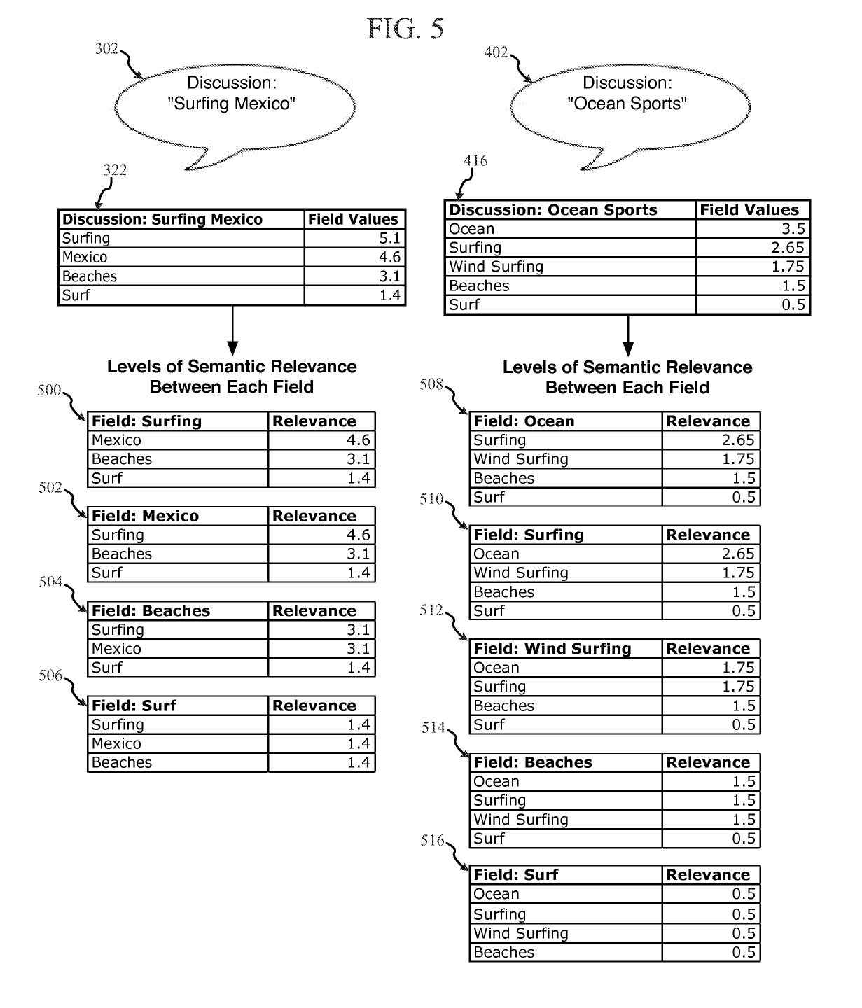

Method 200 then proceeds to provide an indication of the relevance between Fields, i.e. Field Relevance, for at least one First Entity, block 228. As indicated by the dotted lines, this information is retrieved from the database for the particular Entity of interest. The determination of these relevancies is further shown and described with respect to FIGS. 5-8 below.

Moreover, method 200 is permitting a semantic understanding of Fields as they relate to each other. In other words, with respect to FIG. 3 by way of example, the Fields 310 for an Entity, i.e. First Entity, are correlated to each other—Surfing, Mexico, Beaches, and Surf. For at least one embodiment, this correlation is achieved at least in part by determining Field Relevance, which is a value based upon the respective Field values. This correlation permits the semantic understanding that when the First Entity refers to “surf” there is a far greater likelihood that the definition of “surf” should be understood and appreciated in the context of beaches, Mexico and surfing rather then for an action of exploring the Internet.

In other words the context of association of one Field to another advantageously permits not only identification of relevance, but also the correct context between Fields—i.e., the Field “Jaguar” in a Discussion about sports teams is significantly different from the Field “Jaguar” in a Discussion about “Jungle Cats.” Similarly, expressions such as “Hot Dog” can be contextually determined based on Discussion to be a food, a canine with an elevated temperature, or perhaps an expression of amazement.

Likewise, it may be assumed that a User Entity with a number of Fields that relate to sports, or more specifically, the National Football League, has a higher probability of using the term Jaguars as it relates to the football team, over Jaguars that may relate to the Jungle cat or the luxury vehicle. For a Community dedicated to food, there is a higher probability that the word “Hot Dog” refers to the food rather than a canine with an elevated blood pressure.

This is fundamentally different from searching for a first term within X words or characters of a second term, as the analysis is driven directly by associated contextual use of the Fields and not by the arbitrary notion that if used within X the terms must be related. Indeed embodiments of the present invention can establish contextual relationships to be understood with advantageous scope that transcends individual instances of use of the terms and permits contextual awareness with respect to Entities of different types.

Of course, it is understood and appreciated that in many cases there will be a large plurality of Fields such that a full display of all Associated Fields is impractical. As such, a selection of the top most relevant terms may be provided. Alternatively, a collection of the most relevant terms with respect to the terms most recently used in the last Response may be provided.

Although the Semantic Determining System 100 may display a measurement of relevance between Fields as they relate to each Entity, the Semantic Determining System 100 can also display the relevance of Entities based on the relevance of Fields shared between Entities. The display of relevance to one or more other Entities can be substantially real time. A User of the Semantic Determining System 100 may also select to query for probable meaning of words as they relate to a specific Entity or type of Entity—i.e., other Users, Posts, Discussions, Communities, Groups, etc.

Method 200 may also permit the Users to request a comparison for relevance between various different Entities, i.e. a First Entity and a Second Entity—such as a User and a Community of Discussions so that the User may identify Discussions that he or she was unaware of, but which would likely be of interest, decision 230. Again, as shown by dotted lines, this information is pulled from the database for the appropriate entities of interest.

Should the User desire such a comparison, decision 230, then method 200 proceeds to provide an indication of the relevance as between multiple specified entities, block 232.

In most cases, it is desired for Method 200 to continue, decision 234, and so method 200 returns to a state of monitoring the Social Network(s) for Entry/Response, block 206.

To briefly summarize, method 200 operates to determine semantics, and the probable meaning of words as they relate to different Entities on at least one Social Network. This is achieved by, for a First Entity, gathering Metadata from at least one posting by a First User on a First Social Network to define at least one First Field associated with the First Entity, provided by the at least one First User and occurring in the at least one posting, each First Field associated with the First Entity having an initial system generated value. Method 200 continues by evaluating Responses to the posting by at least one Third Party, and in Response to the Third Party using one or more of the First Fields associated with the First Entity in the Response, incrementing the value of each used First Field associated with the First Entity by the addition of a system generated value. And finally, Method 200 provides an indication of relevance for each First Field in relation to at least one Second Field associated with each First Entity, the indication of relevance permitting a determination of semantics for each associated Field of the First Entity.

Method 200 may also be performed for a Second Entity, or an additional First Entity. Moreover, method 200 may be performed for a Second Entity by gathering Metadata from at least one posting by a First User on a First Social Network to define at least one First Field associated with the Second Entity, provided by the at least one First User and occurring in the at least one posting, each First Field associated with the Second Entity having an initial system generated value. Method 200 then continues by evaluating Responses to the posting by at least one Third Party, and in Response to the Third Party using one or more of the First Fields associated with the Second Entity in the Response, incrementing the value of each used First Field associated with the First Entity by the addition of a system generated value. And finally, method 200 may provide an indication of relevance for each First Entity in relation to at least one Second Entity through a determination of relevance between Fields that relate to each Entity, the indication of relevance permitting a determination of semantics for each Entity.

The indications of relevance between Fields associated with an Entity, i.e., First Entity are further exemplified with respect to FIGS. 5-8, which conceptually illustrates Field Relevance Tables.

More specifically, FIG. 5 shows the conceptual Field Value table 322 shown above in FIG. 3. From the values of this Field Value table 322, Field relevance values are shown in Field Relevance Table 500 for the Field Surfing, Field Relevance Table 502 for the Field Mexico, Field Relevance Table 504 for the Field Beaches, and Field Relevance Table 506 for the Field Surf. As noted above, the Field values are derived through Discussion, such as Surfing Mexico 302. For at least one embodiment the Field Relevance is determined in accordance with the equation:

Field Relevance=((Field1+Field2)−(Field1−Field2))/2

Moreover, in order to establish the relevance between the Fields Surfing (Field Value=5.1) and Mexico (Field Value 4.6) as shown in table 322, the Field Relevance equation is applied as:

4.6=((5.1+4.6)−(5.1−4.6))/2

With respect to Field value table 322 it is noted that the high Field value is 5.1 and the low Field value is 1.4 thereby establishing a range from 1.4 to 5.1. As the determined Field Relevance value is 4.6 and therefore closer to the top end of the range it is understood and appreciated that there is a high relevance between Surfing and Mexico with respect the first Entity of the Discussion Surfing Mexico 302.

Of course it should be understood and appreciated that other methods of calculating Field Relevance based on the Field Values may also be employed, and multiple methods may even be employed in the same embodiment further improve the statistical determination of probable meaning and relevance between terms.

FIG. 5 also shows the conceptual Field value table 416 shown above in FIG. 4. From the values of this Field value table 416, Field relevance values are shown in Field Relevance Table 508 for the Field Ocean, Field Relevance Table 510 for the Field Surfing, Field Relevance Table 512 for the Field Wind Surfing, Field Relevance Table 514 for the Field Beaches, and Field Relevance Table 516 for the Field Surf. In each of these tables, the Field Relevance has been determined in accordance with the same above equation.

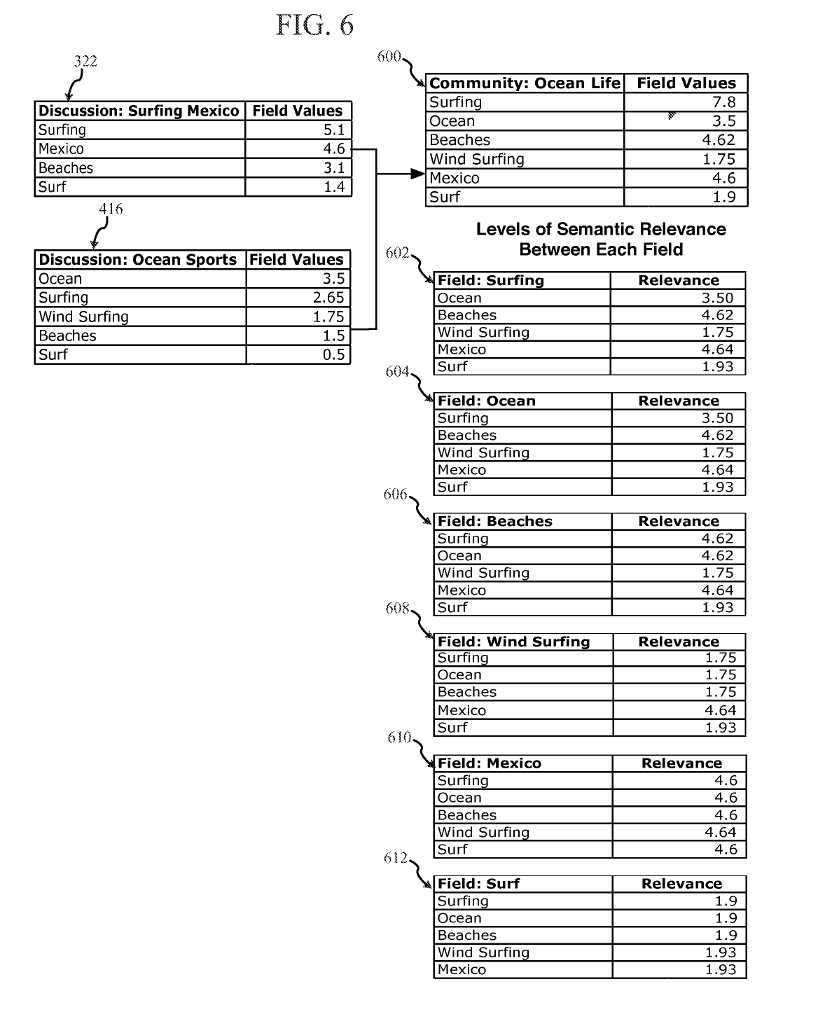

As noted above, for at least one embodiment Entities may be nested. The Fields and Field Values for each lessor Entity can be complied in order to determine the Fields and Field Values for the next higher order Entity. More specifically, as Surfing Mexico 302 and Ocean Sports 402 are both Discussions occurring under Ocean Life 306, Ocean Life 306 as an Entity enjoys the aggregation of the Fields and Field Values from the Discussions Surfing Mexico 302 and Ocean Sports 402 as is shown in FIG. 6.

As shown, Field Value Table 322 for Surfing Mexico 302 and Field Value Table 416 for Ocean Sports 402 are aggregated to provided Field Value Table 600 for the Entity of Ocean Life 306.

As in the case of each distinct Discussion as an Entity, the order of Field Relevance between the aggregated Fields for Community Ocean Life 306 is calculated through a function that accurately weighs the level of relevance between each Field. For at least one embodiment, this is the same equation noted above.

Moreover, in order to establish the relevance between the Fields Surfing (Field Value=7.8) and Beaches (Field Value=4.62) Field Value Table 600, we use Values for these Fields to determine a measure of relevance: i.e. ((7.8+4.62)−(7.8−4.62))/2=4.62.

Field Relevance calculations are shown for each of the associated Fields, Surfing, Ocean, Beaches, Wind Surfing, Mexico and Surf, in respective Field Relevance tables, 602, 604, 606, 608, 610 and 612.

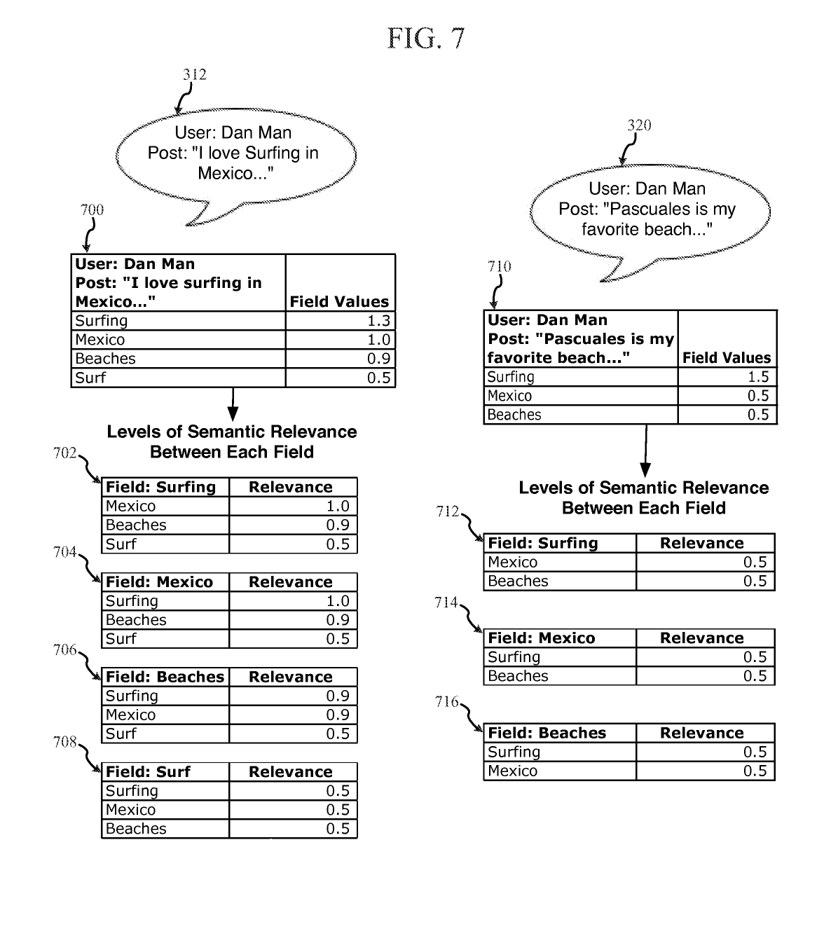

This same methodology may be advantageously applied to other Entities as well, such as for example a User Entity or even the posts of the User. FIG. 7 demonstrates this same process as applied to the User Dan Man 324 for each of his posts “I love surfing in mexico . . . ” 312 and “Pascuales is one of my favorite beaches . . . ” 320. More specifically tables 700 and 710 show the associated Field Values established for each post. Field Relevance tables 702, 704, 706 and 708 further illustrate the determined Field Relevance Values for each Field shown in table 700 and similarly Field Relevance Tables 712, 714 and 716 show the determined Field Relevance Values for each Field shown in Table 710.

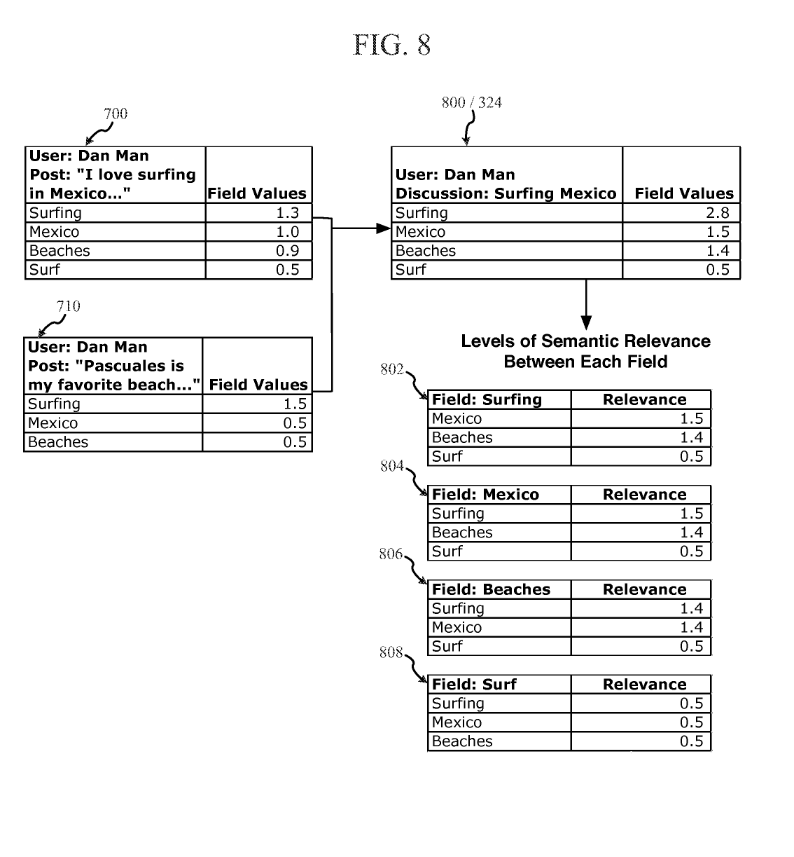

As with FIG. 6, FIG. 8 demonstrates how the Fields and Field Values from the post 312 “I love Surfing in Mexico . . . ” and post 320 “Pascuales is my favorite beach . . . ” are compiled into an aggregate table 800 for the Entity of User Dan Man over the entire Discussion “Surfing Mexico” 302. This aggregation allows the Semantic Determining System 100 to determine relevance between Fields 310 Surfing, Mexico, Beaches, Surf as shown in Field Relevance tables 802-808 that relate specifically to the User Dan Man for the Discussion “Surfing Mexico” 302.

Subsequently, the Fields, Field Values and Field Relevance can continue to be aggregated for every Discussion that User Dan Man is a part of over a specific Community, in order to determine Semantic Relevance between Fields for Dan Man within that Community. If Dan Man is a member of multiple Communities then the aggregate can be adjusted in order to provide Global Aggregate Fields, Field Value, and Field Relevance for the User Dan Man.

At whatever level is achieved for Dan Man, the aggregation of Fields, Field Value and Field Relevance can be used across other platforms, or online communities order to provide a semantic understanding of Dan Man in online environments Dan Man is a newcomer to, and/or to identify environments that may be of interest to Dan Man.

More specifically, if Dan Man joins a new Social Network or online Community the Semantic Determining System 100 can be used to understand, validate or recognize that if Dan Man provides a post that says simple, “I love surfing” the established Field Relevancies with his other associated Fields indicates that Dan Man is almost certainly talking about surfing as an activity involving Beaches, Ocean and Mexico (i.e., other Fields associated with Dan Man), not browsing the internet or some other unrelated context for the term “Surfing.”

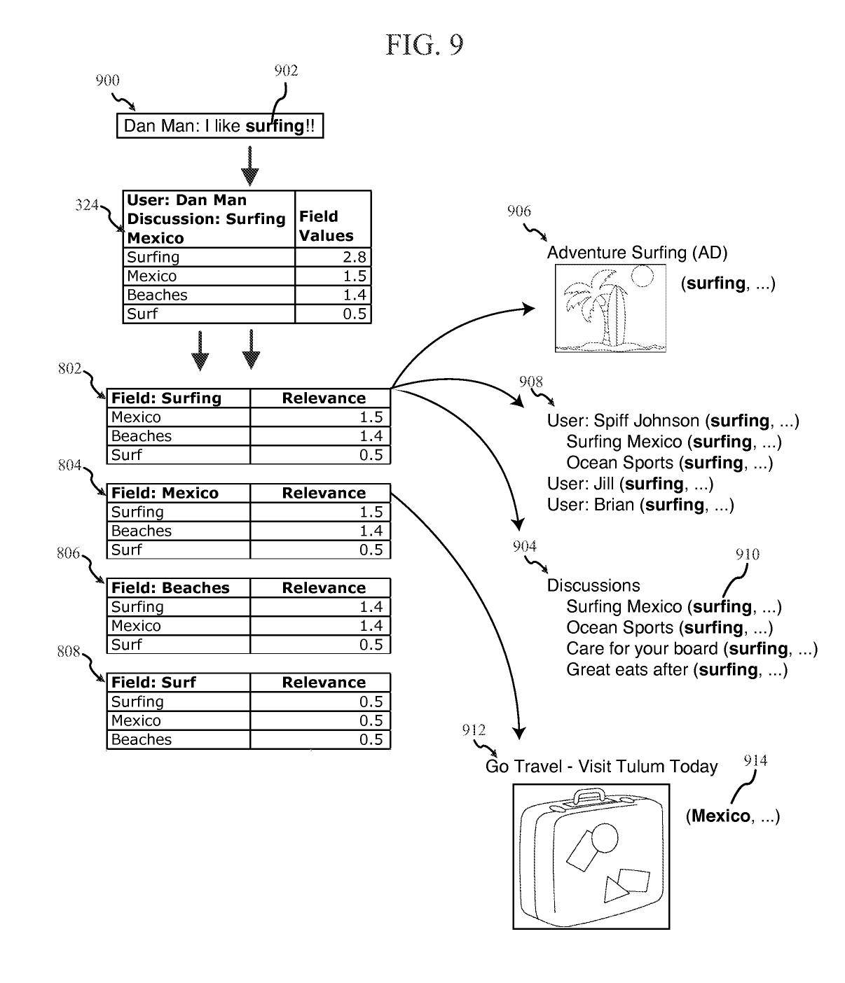

FIG. 9 further illustrates this point. From the Entry/Post 900 by Dan Man “I like surfing,” surfing is recognized as a Field 902 and the associated Field Relevancies from his participation in the Discussion Surfing Mexico 302 are retrieved as is conceptually illustrated by table 324 and tables 802, 804, 806 and 808. One or more of these tables 324, 802, 804, 806 and 808 need not be displayed to the User Dan Man, or other Users of the Semantic Determining System 100, though they may be in at least some embodiments. Of course the retrieved Field Relevancies may also be derived from Dan Man's participation over the entire Community and/or multiple Communities and or the Community as a whole. In addition, the Field Relevancies may also be filtered for specific Fields and or time periods.

Based on surfing as well as these other associated Fields Mexico, Beaches, Surf and their Field Relevancies, a targeted search may be performed to identify Discussions 904 which Dan Man may or may not be aware of, Adds 906 for trips or materials relating to surfing, Users 908 who appear to share similar interests with Dan Man, etc., i.e., other Entities that may be of interest to Dan Man. For at least one embodiment this determination of potential relevance is based at least in part on the other Entity sharing at least one associated Field in common with Dan Man, i.e., Field 910 for surfing as shown for Discussion Surfing Mexico. The Field Value for Field 910 surfing may be further used to evaluate the likelihood of relevance. In other words, for each of the conceptual potential Entities, the associated Field should have a field value (not shown) of at least a determined threshold.

It should also be understood and appreciated that new Entities may be identified based on the associated Fields which have established Relevance for Dan Man. Moreover, at least one exemplary Entity identified and presented to Dan Man is “Go Travel—Visit Tulum Today!” 912 on the basis that Tulum a famous site of ruins in Mexico that is on the ocean. Mexico is an associated Field to Dan Man with high Field Relevance, and Mexico is shown to be an associated Field 914 to “Go Travel—Visit Tulum Today!” 912. Moreover it is the ability to use Field Relevancies to identify key Fields for matching with one or more other Entities so as to identify Entities of interest.

Of course it is understood and appreciated that the values as set forth herein have been developed from a very short conceptual set of Discussions. In real world application, the developed values would in general be far greater. Of course a low level Entity may have very few associated Fields and those Fields may indeed have low Field values, but the conceptual point is still made. By comparing the relative values a semantic awareness of terms is quickly achieved.

With respect to the Fields shown for the Entities of Discussions 300, 400 and the Entity of Community Ocean Life, if another Entity having the terms “Internet,” “web browsing,” “Mexico” were compared, only Mexico would match as having some possible relevance, but the lack of any match between any other terms would indicate that the semantic understanding of Mexico with respect to the new Entity has nothing to do with “surfing” or “beaches.”

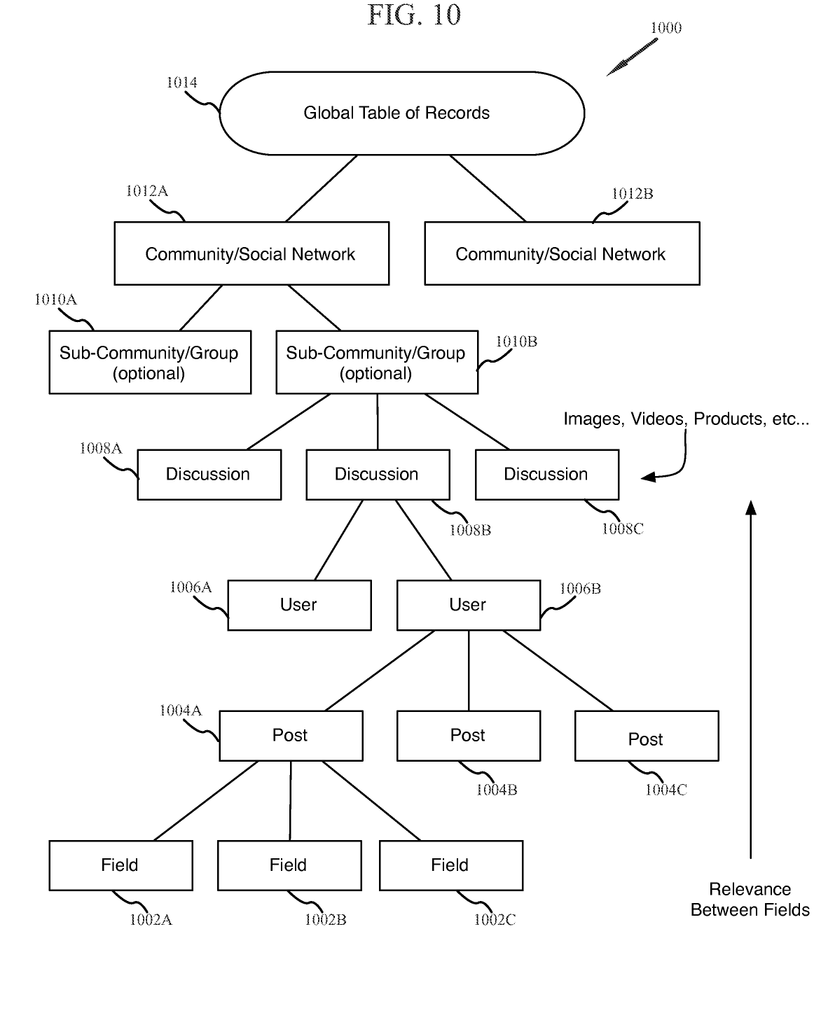

FIG. 10 illustrates the scope of the Semantic Determining System 100 for at least one embodiment, and the nested relationships that can be determined between Entities based on Fields, Field Values and Field Relevance across a Social Hierarchy 1000. For example, Fields 1002A, 1002B and 1002C are associated with Post 1004A. Posts 1004A, 1004B and 1004C are associated with User 1006B. Users 1006A and 1006B are associated with Discussion 1008B. Discussions 1008A, 1008B and 1008C are associated with Sub-Community/Group 1010B. Sub-Community/Group 1010A and Sub-Community/Group 1010B are associated with Community/Social Network 1012A. And Community/Social Network 1012A and Community/Social Network 1014B are associated with a Global Entity in a global table of records for all Fields, Field Values and Field Relevancies that have been generated through online Discussion in an automated fashion free of user subjectivity. Again, this depicted Social Hierarchy 1000 is merely exemplary of how nested hierarchical relationships may be established between Entities for at least one embodiment. Alternative titles for the Entities and different arrangements of the Entities is understood and appreciated to be within the scope of the present invention.

Subsequently, the Semantic Determining System 100 can establish Field relevance to 3rd-party applications as well. This includes, but is not limited to applications that relate to Search, Advertising, API's, Recommendations, Education, Skill Matching, requests for Analytics/Credentials, or any other application that may benefit from semantic understanding of words as they relate to various Entities that comprise the Semantic Determining System 100.

The ability to establish semantic relationships between Fields shared by entities allows for implicit relationships between entities; i.e. matching Entities that do not contain the same Fields, but rather, Fields that relate to other Fields. For example, the Semantic Determining System 100 could determine that the Field “Ocean” can also relate to the Discussion Surfing Mexico 302 because of its implicit relevance to the Fields “Surfing”, “Surf” and “Beaches” in the Discussion Ocean Sports 402. Therefore, the Semantic Determining System 100 could recommend the Discussion Ocean Sports 300 to Users that are part of the Discussion Surfing Mexico 302 due to the shared relations between the Fields “Surfing”, “Mexico”, and “Beaches”. This implicit approach to establishing similarities can occur between any Entities that comprise the Semantic Determining System 100.

For 3rd-party applications, an advertisement can be directed to an Entity such as a Post, a User, a Discussion, a Group, or a Community based on relationships between Fields that relate to the advertisement. For instance, keywords can be associated to an advertisement by the advertiser, through a keyword generator, or through a Discussion that relates to the product or services the ad is for. These keywords can subsequently relate to Fields that relate to a User, Discussions and communities with the same Fields, or implicitly through Fields with high level of relevance between Fields. For the Community Ocean Sports 402, an article, post, or Response that only has an association to the Field “Ocean” Could generate an Ad that relates to the Fields “Beaches”, “Wind” “Surf” and “Surfing” due to the inherent relevance between Fields that exists over that Community. Likewise, a User with an interest in “Surfing” and “Mexico” could be directed to Discussions and Communities talking about “Beaches,” “Surf,” or directed to Ads that represent travel options or businesses that indirectly relate to “Surfing” and “Mexico”.

Likewise, if a single Field identifies an Entity, i.e. a User posts “I like Surfing,” through determining the relevance that exists between other Fields, the Semantic Determining System 100 can determine a probability score that the term “Surfing” relates to “Mexico” “Beaches” “The Internet” or some other Field of interest. The ability to establish Field Relevance for each Entity (Post, User, Discussion, Group, Sub-Community, Community, etc.,) is extremely advantageous because the word “Surfing” could mean something totally different for another User, used in the context of another Discussion, or across a different Community. Therefore, an advertisement, a recommendation, a search, etc., based upon the term “Surfing” can all generate different results based on the Entities Field Relevance to the term “Surfing.”

The Semantic Determining System 100 can also be utilized to identify the relationships between other Fields, terms or keywords. For example, someone could post “Joe really knows his sports.” Through identifying similarities between Entities through their relational Fields, the Semantic Determining System 100 can identify if “Joe” is referring to “Joe Montana” the NFL football star, or “Joe Buck” the sports announcer. Likewise, “I like Dogs” could be understood to mean a type of dog such as a poodle or a pitbull, or to the food hotdog based on the Field Relevance of terms that relate to those different types of “Dogs.” Since each Entity of the Semantic Determining System 100 establishes Field Relevance, these distinctions can be made for each Entity. For instance, the Field Relevance of “Joe” or “Dog” can be made for a User, a Post, a Discussion, a Group or a Community.

Likewise, abbreviations and pseudonyms are used all the time when referring to the names of people, places or things. If someone uses the term “MJ” how do we know if they are referring to Michael Jackson, the famous musician, or Michael Jordan, the famous basketball player. The Semantic Determining System 100 can predict the probable meaning of a word through understanding the relevance between other Fields that relate to that word. On a Web site dedicated to the National Basketball Association, or for a User who frequently discusses sports, Fields associated with “MJ” could be matched against Fields that relate to Michael Jordan and Michael Jackson.

With respect to the above description of Semantic Determining System 100 and method 200 it is understood and appreciated that the method may be rendered in a variety of different forms of code and instruction as may be used for different computer systems and environments. To expand upon the initial suggestion of a computer implementation above, FIG. 10 is a high level block diagram of an exemplary computer system 1100. Computer system 1100 has a case 1102, enclosing a main board 1104. The main board 1104 has a system bus 1106, connection ports 1108, a processing unit, such as Central Processing Unit (CPU) 1110 with at least one macroprocessor (not shown) and a memory storage device, such as main memory 1112, hard drive 1114 and CD/DVD ROM drive 1116.

Memory bus 1118 couples main memory 1112 to the CPU 1110. A system bus 1106 couples the hard disc drive 1114, CD/DVD ROM drive 1116 and connection ports 1108 to the CPU 1110. Multiple input devices may be provided, such as, for example, a mouse 1120 and keyboard 1122. Multiple output devices may also be provided, such as, for example, a video monitor 1124 and a printer (not shown).

Computer system 1100 may be a commercially available system, such as a desktop workstation unit provided by IBM, Dell Computers, Gateway, Apple, or other computer system provider. Computer system 1100 may also be a networked computer system, wherein memory storage components such as hard drive 1114, additional CPUs 1110 and output devices such as printers are provided by physically separate computer systems commonly connected together in the network. Those skilled in the art will understand and appreciate that the physical composition of components and component interconnections are comprised by the computer system 1100, and select a computer system 1000 suitable for the establishing the Authentication System 100.

When computer system 1100 is activated, preferably an operating system 1126 will load into main memory 1112 as part of the boot strap startup sequence and ready the computer system 1100 for operation. At the simplest level, and in the most general sense, the tasks of an operating system fall into specific categories, such as, process management, device management (including application and User interface management) and memory management, for example. The form of the computer-readable medium 1128 and language of the program 1130 are understood to be appropriate for and functionally cooperate with the computer system 1100.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall there between.

What is claimed is:

1. A method to determine semantics, and the probable meaning of words as they relate to different Entities on at least one Social Network comprising:
for at least one First Entity, gathering Metadata from at least one posting by a First User on a First Social Network to define at least one First Field associated with the First Entity, provided by the at least one First User and occurring in the at least one posting, each First Field associated with the First Entity having an initial system generated value;
evaluating Responses to the posting by at least one Third Party, and in response to the Third Party using one or more of the First Fields associated with the First Entity in the Response, incrementing the value of each used First Field associated with the First Entity by the addition of a system generated value; and
providing an indication of relevance for each First Field in relation to at least one Second Field associated with each First Entity, the indication of relevance permitting a determination of semantics for each associated Field of the First Entity.

2. The method of claim 1, wherein the Second Field associated with each First Entity has a value established by:
gathering Metadata from at least one posting by a First User on a First Social Network to define at least one Second Field associated with the First Entity, provided by the at least one First User and occurring in the at least one posting, each associated Second Field having an initial system generated value; and
evaluating Responses to the posting by at least one Third Party, and in response to the Third Party using one or more of the associated Second Fields in the response, incrementing the value of each used associated Second Field by the addition of a system generated value.

3. The method of claim 1, wherein there are a plurality of First Fields, the Second Field being one of the additional First Fields.

4. The method of claim 1, wherein the indication of relevance further permits identification of component Fields.

5. The method of claim 1, wherein providing an indication of the relevance of each First Field includes evaluating the relevance of each Field to one another to establish a table providing a context of relevance between Fields to identify a degree of semantics for the First Entity through the relevance between each Field that are associated to the First Entity.

6. The method of claim 5, wherein the context of reference provided by the table is a system determined number.

7. The method of claim 5, wherein the context of relevance is determined by comparing the value of a First Field for a First Entity to the value of each other Field of the First Entity.

8. The method of claim 1, wherein the Social Network has a plurality of nested entities, a higher level Entity assuming the valuation of associated Fields from lower level entities.

9. The method of claim 1, wherein the Social Network has a plurality of entities arranged as Users, Posts, Discussions, Groups, Communities, Social Networks.

10. The method of claim 1, wherein the First Entity is selected from the group consisting of, the First User, the Posting by the First User, the First Social Network, a Community, a Second Social Network, a First Discussion, a Second Discussion, an Interest.

11. The method of claim 1, wherein the method is performed for a Second Entity, the method further comprising:
for at least one Second Entity, gathering Metadata from at least one posting by a First User on a First Social Network to define at least one First Field associated with the Second Entity, provided by the at least one First User and occurring in the at least one posting, each First Field associated with the Second Entity having an initial system generated value;
evaluating Responses to the posting by at least one Third Party, and in response to the Third Party using one or more of the First Fields associated with the Second Entity in the Response, incrementing the value of each used First Field associated with the First Entity by the addition of a system generated value; and
providing an indication of relevance for each First Entity in relation to at least one Second Entity through a determination of relevance between Fields that relate to each Entity, the indication of relevance permitting a determination of semantics for each Entity.

12. The method of claim 11, wherein providing an indication of the relevance between Entities includes evaluating the relevance of each Field between each Entity to establish a Table providing a context of relevance between Entities based on the relevance of Fields between Entities to identify a degree of semantics for each Entity through the relevance of Fields between Entities.

13. The method of claim 12, wherein the degree of relevance between Entities is based on the relevance of Fields that relate to each Entity.

14. The method of claim 11, wherein providing an indication of relevance for each First Entity includes evaluating the relevance of each Field to one another to establish a Table providing a context of relevance between Entities to identify the First Entity as having a quantified degree of semantics through the relevance between each Entity.

15. The method of claim 11, wherein the context of relevance is determined by comparing the value of at least one of the First Fields associated with the First Entity to the value of each Field associated with the Second Entity.

16. The method of claim 11, wherein field relevance for the First Entity is used to identify Fields associated with at least one Second Entity.

17. The method of claim 11, wherein the First Entity may range from a low order Entity to a high order Entity, the table of a high order Entity including at least one table of a low order Entity.

18. The method of claim 11, wherein the method is performed substantially concurrently with the posting and Responses.

19. A non-transitory machine readable medium on which is stored a computer program for determining similarities between Entities on at least one Social Network the computer program comprising instructions which when executed by a computer system having at least one processor performs the steps of:
for at least one First Entity, gathering Metadata from at least one posting by a First User on a First Social Network to define at least one First Field associated with the First Entity, provided by the at least one First User and occurring in the at least one posting, each First Field associated with the First Entity having an initial system generated value;
evaluating Responses to the posting by at least one Third Party, and in response to the Third Party using one or more of the First Fields associated with the First Entity in the Response, incrementing the value of each used First Field associated with the First Entity by the addition of a system generated value; and
providing an indication of relevance for each First Field in relation to at least one Second Field associated with each First Entity, the indication of relevance permitting a determination of semantics for each associated Field of the First Entity.

20. The non-transitory machine readable medium of claim 19, wherein there are a plurality of First Fields, the Second Field being one of the additional First Fields.

21. The non-transitory machine readable medium of claim 19, wherein the Social Network has a plurality of nested entities, a higher level Entity assuming the valuation of associated Fields from lower level entities.

22. The non-transitory machine readable medium of claim 19, wherein providing an indication of the relevance between Entities includes evaluating the relevance of each Field between each Entity to establish a Table providing a context of relevance between Entities based on the relevance of Fields between Entities to identify a degree of semantics for each Entity through the relevance of Fields between Entities.

23. The non-transitory machine readable medium of claim 22, wherein the degree of relevance between Entities is based on the relevance of Fields that relate to each Entity.

24. The non-transitory machine readable medium of claim 22, wherein providing an indication of relevance for each First Entity includes evaluating the relevance of each Field to one another to establish a Table providing a context of relevance between Entities to identify the First Entity as having a quantified degree of semantics through the relevance between each Entity.

25. The non-transitory machine readable medium of claim 22, wherein the context of relevance is determined by comparing the value of at least one of the First Fields associated with the First Entity to the value of each Field associated with the Second Entity.

26. The non-transitory machine readable medium of claim 22, wherein field relevance for the First Entity is used to identify Fields associated with at least one Second Entity.

27. The non-transitory machine readable medium of claim 19, wherein providing an indication of the relevance of each First Field includes evaluating the relevance of each Field to one another to establish a table providing a context of relevance between Fields to identify a degree of semantics for the First Entity through the relevance between each Field that are associated to the First Entity.

28. A computer system having at least one physical processor and memory adapted by software instructions to determine semantics, and the probable meaning of words as they relate to different Entities on at least one Social Network comprising:
at least one User account in the memory, the User account identifying at least a first Social Network and an associated known User identity;
the processor adapted at least in part by the software as a Metadata gatherer structured and arranged to gather Metadata from at least the first Social Network regarding at least one First Entity, the gathered Metadata including at least one First Field obtained from at least one posting by a First User identity and subsequent third party Responses to the at First User identity;
a database in memory structured and arranged to associate the at least one Field to the at least one First Entity; and
the processor adapted at least in part by the software as a value determiner structured and arranged to evaluate Responses to the posting by at least one Third Party, and in response to the Third Party using one or more of the associated First Fields in the Response, incrementing the value of each used associated First Field by the addition of a system generated value, the value determiner further structured and arranged to provide indication of relevance for each First Field in relation to at least one Second Field associated with each First Entity, the indication of relevance permitting a determination of semantics for each associated Field of the First Entity.

29. The computer system of claim 28, wherein there are a plurality of First Fields, the Second Field being one of the additional First Fields.

30. The computer system of claim 28, wherein the Social Network has a plurality of nested entities, a higher level Entity assuming the valuation of associated Fields from lower level entities.

31. The computer system of claim 28, wherein the degree of relevance between Entities is based on the relevance of Fields that relate to each Entity.

32. The computer system of claim 28, wherein providing an indication of relevance for each First Entity includes evaluating the relevance of each Field to one another to establish a Table providing a context of relevance between Entities to identify the First Entity as having a quantified degree of semantics through the relevance between each Entity.

33. The computer system of claim 28, wherein the context of relevance is determined by comparing the value of at least one of the First Fields associated with the First Entity to the value of each Field associated with the Second Entity.

34. The computer system of claim 28, wherein field relevance for the First Entity is used to identify Fields associated with at least one Second Entity.

35. The computer system of claim 28, wherein providing an indication of the relevance of each First Field includes evaluating the relevance of each Field to one another to establish a table providing a context of relevance between Fields to identify a degree of semantics for the First Entity through the relevance between each Field that are associated to the First Entity.
